(19) United States
(12) Patent Application Publication
(10) Pub. No.: US 2017/0061373 A1
(43) Pub. Date: Mar. 2, 2017

(54) STORAGE EQUIPMENT AND GOODS STORAGE SYSTEM

(71) Applicant: FULLTIME SYSTEM CO., LTD., Tokyo (JP)

(72) Inventor: Shuhei HARA, Tokyo (JP)

(73) Assignee: FULLTIME SYSTEM CO., LTD., Tokyo (JP)

(21) Appl. No.: 15/211,319

(22) Filed: Jul. 15, 2016

(30) Foreign Application Priority Data
Sep. 2, 2015 (JP) 2015-173025

(51) Int. Cl. G06Q 10/08; A47G 29/122; A47G 29/14; A47G 29/12; G06F 17/30; G01G 23/18

(52) U.S. Cl. CPC G06Q 10/0836; G06F 17/30312; G01G 23/18; A47G 29/141; A47G 29/1201; A47G 29/1225; A47G 2029/149; A47G 2029/146; A47G 2029/1228

(57) ABSTRACT

A storage equipment system containing storage equipment and a goods receiving system by which the resident can pick up delivery regardless of a weight of the delivery The storage equipment includes a configuration as a lockable storage to store a delivery of a user-resident and function as a delivery locker to temporarily store the delivery until retrieved by the user-resident. When a delivery service stores a delivery in the storage equipment and inputs a weight; the storage equipment system accepts and authorizes only if the weight of the delivery item addressed to the housing unit is lighter than a predetermined weight value.

### CROSS REFERENCE TO RELATED APPLICATIONS

This application relates to and claims priority from JP Ser. No. 2015-173025 filed Sep. 2, 2015, the entire contents of which are enclosed herein by reference.

### FIGURE SELECTED FOR PUBLICATION

FIG. 1

### BACKGROUND OF THE DISCLOSURE

Technical Field

The present invention relates to storage equipment and a goods storage system therefor and more specifically the storage equipment and the goods storage system can control receiving of a delivery based on weight and a type of the delivery.

Technical Background

Recently, lockable storage equipment, so-called door-to-door delivery locker, is installed in a common area and so forth in the housing complex and is available for the door-to-door delivery service and so forth.

Relative to such door-to-door delivery service the door-to-door carrier can store a delivery addressed to the resident in a receiving box of the door-to-door locker and then lock the receiving box even when the resident is absent and then later the resident can unlock such receiving box to take out the delivery addressed to oneself.

Accordingly, the door-to-door delivery locker is capable of protecting the delivery from e.g., a theft and so forth and of receiving the delivery safe.

As a prior art relative to such door-to-door delivery locker, Patent Document 1 discloses the door-to-door delivery and the communication system of the door-to-door delivery service applying such a door-to-door locker.

According to the Patent Document 1, a communication means is installed to the door-to-door delivery locker and further is connected to the LAN (Local Area Network) installed in the apartment, and then the data can be transmitted and received between the communication means and the personal computer, which is connected to the LAN, of the resident in each housing unit. Then, when goods are delivered to the door-to-door delivery locker, the data relative to the goods are sent to the computer of each housing unit via the LAN so that the resident can be informed that the delivery addressed to oneself has been delivered to the door-to-door delivery locker and then go to pick up at the earliest convenient time, as results, the enough number of available boxes can be ensured and the delivery service can be efficiently achieved, accordingly.

### PRIOR ART

### Patent Document

Patent Document 1: JP Patent Published 2002-34771

### ASPECTS AND SUMMARY OF THE PRESENT INVENTION

### Aspects to be Addressed

However, according to the door-to-door delivery locker of the Patent Document 1 and so forth, since the user can be informed relative to delivery per se but cannot understand about the detail content of the delivery, it is problematic that although the resident goes to the entrance, at which the door-to-door delivery lockers are installed, to pick up the delivery, the resident may not bring back because the delivery is too heavy to bring back or too hard to bring back depending on the type of the delivery per se.

The present invention is motivated to resolve such problems described above and the purpose of the present invention is to provide storage equipment and a goods storing system by which the resident can pick up effortlessly such delivery regardless weight of the delivery, which is heavier than the predetermined weight, and the type thereof.

### Means for Solving the Problem

Storage equipment of the present invention so as to achieve such purpose comprises at least one storage box that can receive and store temporarily goods until a user as the recipient takes out the goods, and further comprises a database that controls the benchmark value for reject of receiving the goods heavier than the predetermined weight every user, wherein receiving in the storage box is rejected if the input weight is heavier than the benchmark value referring to the database when weight of the goods is input

In addition, the storage equipment of the present invention comprises at least one storage box that can receive and store temporarily the goods until the user as the recipient takes out the goods, and further comprises a database that controls the benchmark value to reject receiving of the goods heavier than the predetermined weight every user, wherein the receiving into the storage box is rejected in the storage box in the location other than designated location if the input weight is heavier than the benchmark value referring to the database when the weight of the goods is input

In addition, the storage equipment of the present invention comprises at least one storage box that can receive and store temporarily the goods until the user as the recipient takes out the goods, and further comprises a database that controls a location of the goods storage box when the goods having heavier weight than the predetermined benchmark value are being received, wherein receiving in the storage box at lower rows among available boxes is suggested if the input weight is heavier than the benchmark value referring to the database when weight of the goods is input.

In addition, the storage equipment of the present invention comprises at least one storage box that can receive and store temporarily the goods until the user as the recipient takes out the goods, and further comprises a database that controls a location of the goods storage box when the goods having lighter weight than the predetermined benchmark value are received, wherein receiving in the storage box at higher rows among the available boxes is suggested if the input weight is lighter than the benchmark value referring to the database when the weight of the goods is input

In addition, the storage equipment of the present invention comprises at least one storage box that can receive and store temporarily the goods until the recipient as the user takes out the goods, and further comprises a database that controls a type of goods, of which receiving is unacceptable in the storage box, a resident by a resident, wherein the receiving in the storage box is rejected if the input type of the goods is unacceptable referring to the database when the type of the goods is input.

Further, according to the present invention, a goods storage system comprises storage equipment and a user terminal connected to the storage equipment via a network and operated by the user as the recipient, wherein the storage equipment sends a package data indicating that the goods were received in the storage box to the user terminal and the package data include the data relative to the weight of the goods.

Further, according to the present invention, a goods storage system comprises storage equipment and a user terminal connected to the storage equipment via a network and operated by a user as the recipient, wherein the storage equipment sends the package data indicating that the goods were received in the storage box to the user terminal and the package data include the data relative to the type of the goods.

In addition, according to the present invention, a goods storage system comprises at least one storage box that can receive and store temporarily the goods until a user as the recipient takes out the goods and a user terminal is operated by the user as the recipient of the goods connected to the storage equipment via a network, wherein the storage equipment sends the package data indicating that the goods were received in the storage box to the user terminal and the package data include the total number of received and stored in the own equipment assigned to the addressed recipient of the goods.

Further, according to a goods storage system of the present invention, storage equipment sends the package data as the data displayable on the screen via e.g., e-mail, web page or preset software to the user terminal.

In addition, according to the present invention, a goods storage system comprises the above storage equipment and a user terminal connected to the storage equipment via a network and operated by a user as the recipient, wherein the control equipment sends the package data, including the data relative to weight of the goods, to the user terminal when received the package data indicating that the goods were received in the storage box.

Further, according to the present invention, a goods storage system comprises the above storage equipment and a user terminal connected to the storage equipment via a network and operated by a user as a recipient, wherein the control equipment sends the package data including the data relative to a type of the goods, to the user terminal when received the package data indicating that the goods were received in the storage box.

Further, according to the present invention, a goods storage system comprises; at least one storage box, storage equipment that can receive and store temporarily the goods until a user as the recipient takes out the goods, a user terminal that is connected to the storage equipment via a network and operated by the user at the recipient of the goods, and the control equipment connected to the storage equipment and the user terminal via the network, wherein the control equipment sends the package data, including the data indicating the total number of goods stored in the own equipment of the addressee of the goods, to the user terminal when received the package data indicating that the goods were received in the storage box.

Further, according to the goods storage system of the present invention, a control device sends the package data as the data displayable on the screen by e.g., e-mail, web page or preset software to the user terminal.

In addition, any combination of the structure elements described above, and any replacements each other between the structure element and the expression method, the equipment, the system, the computer program and the medium receiving the computer program of the present invention are effective as one aspect of the present invention.

### Effect of the Invention

According to the present invention, the number of received and stored goods is noticed to the user and the acceptance/rejection of the received goods into the storage equipment and the location of the storage box and so forth are decided based on the weight and/or type of the goods so that the user per se can receive in accordance with the desirable method for user per se or and prepare the way to receive the goods in advance and the user can be facilitated to receive the goods.

### BRIEF DESCRIPTION OF THE DRAWINGS

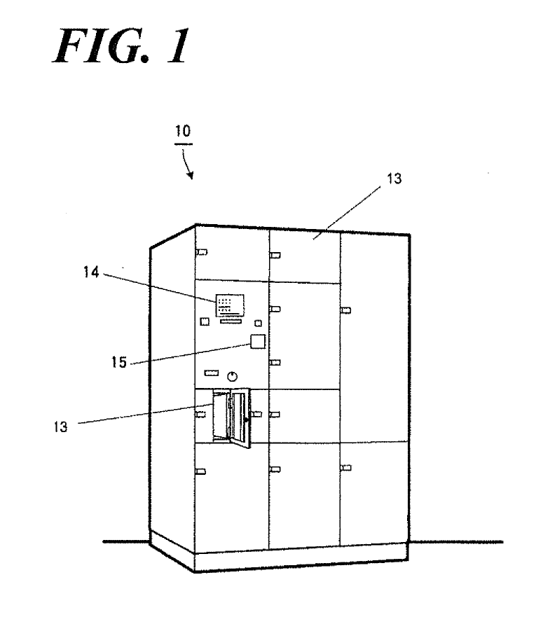

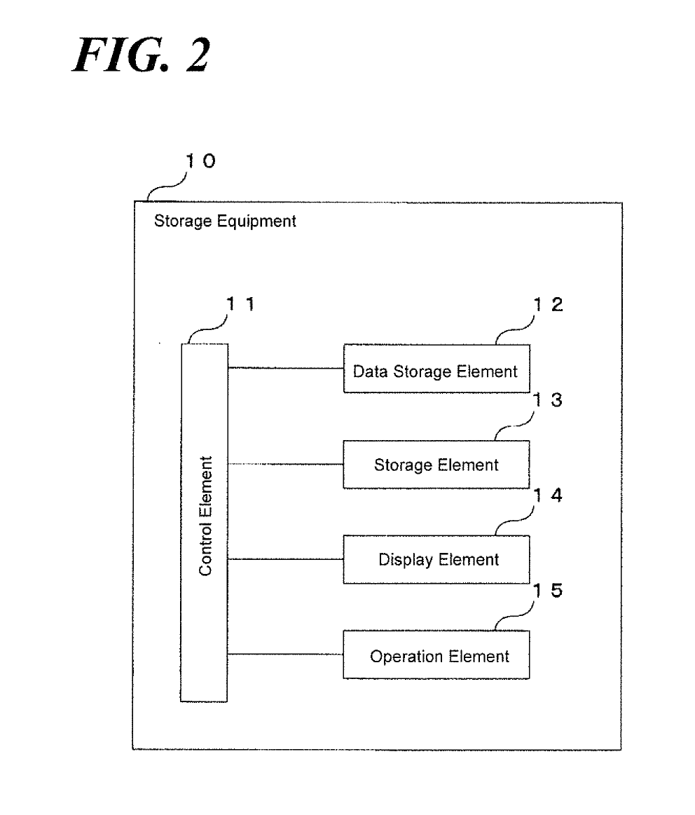

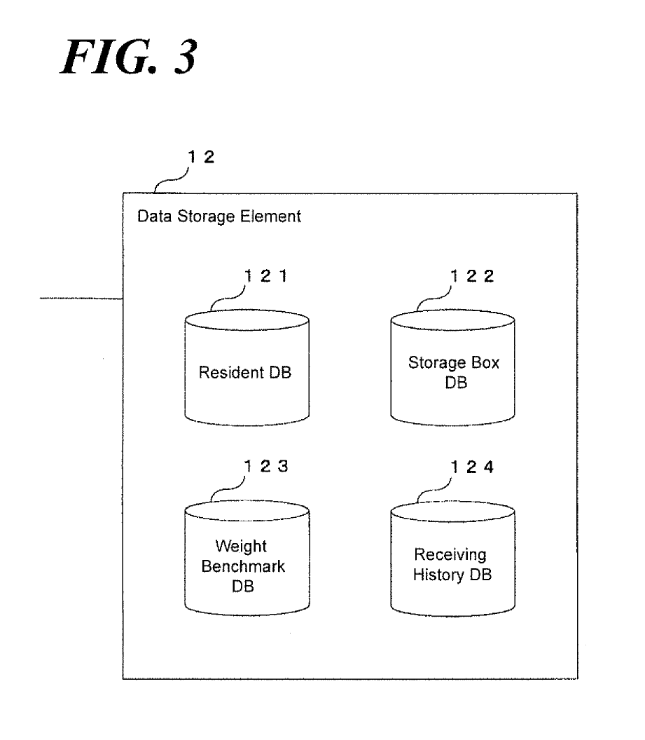

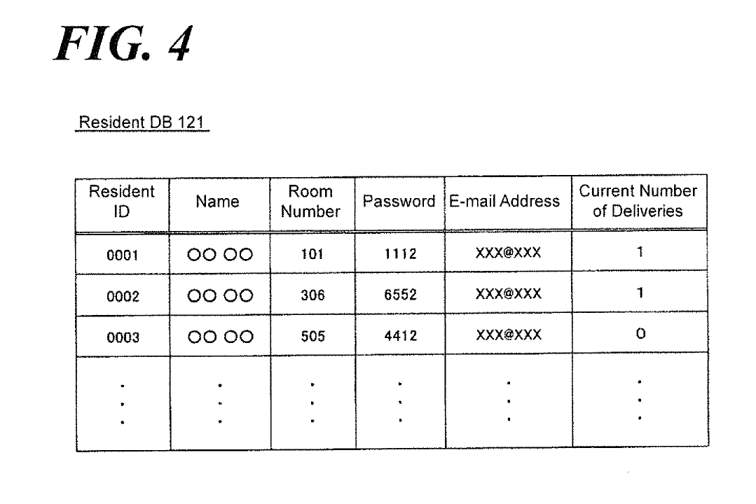

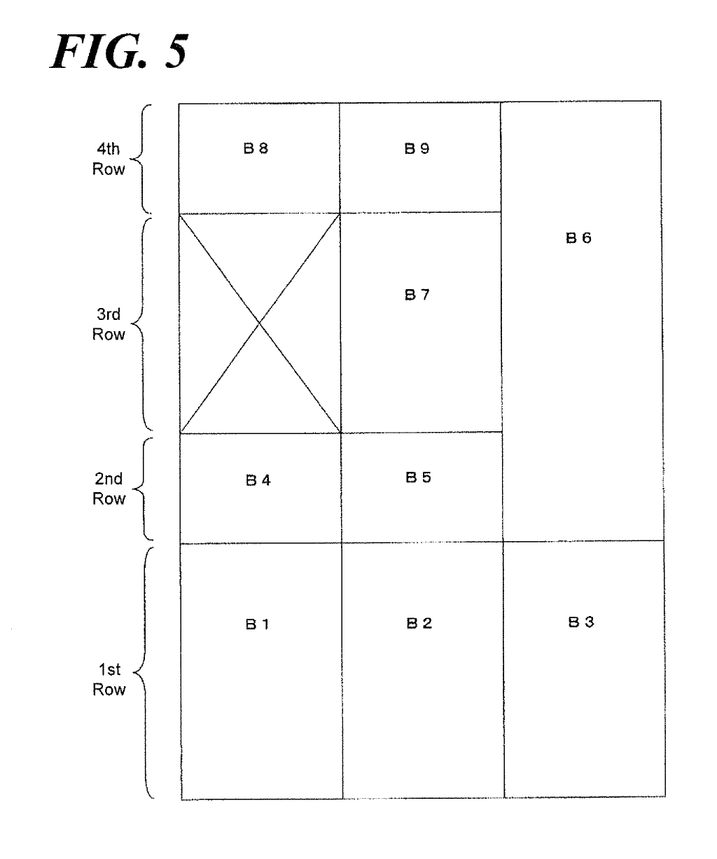

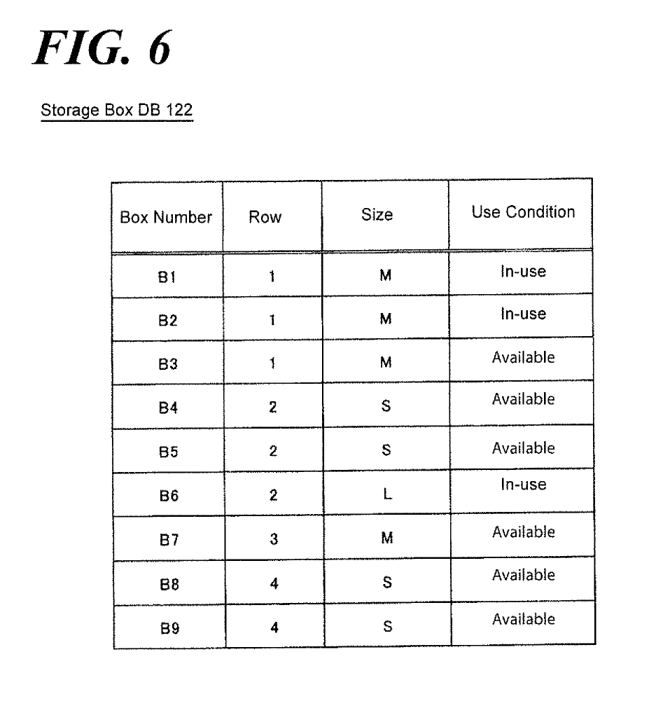

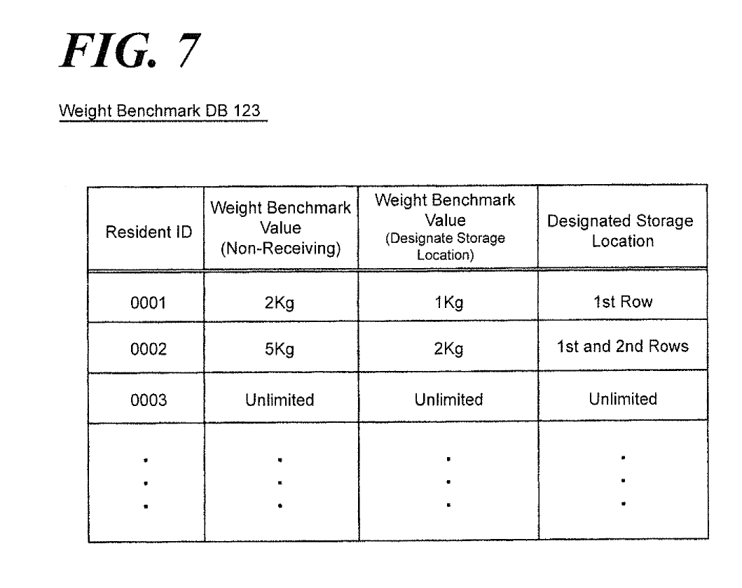

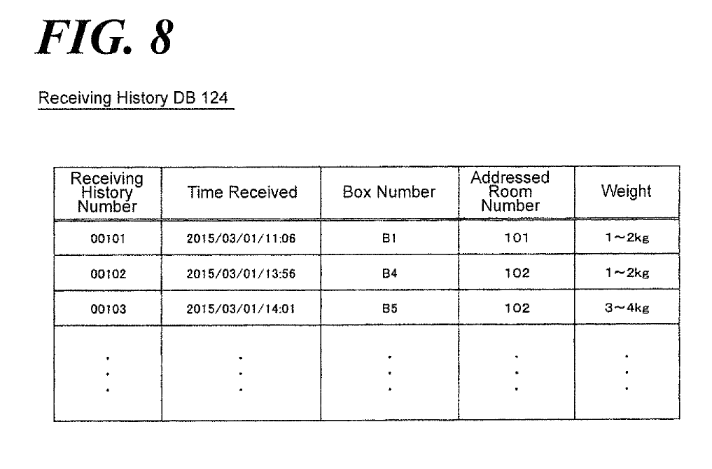

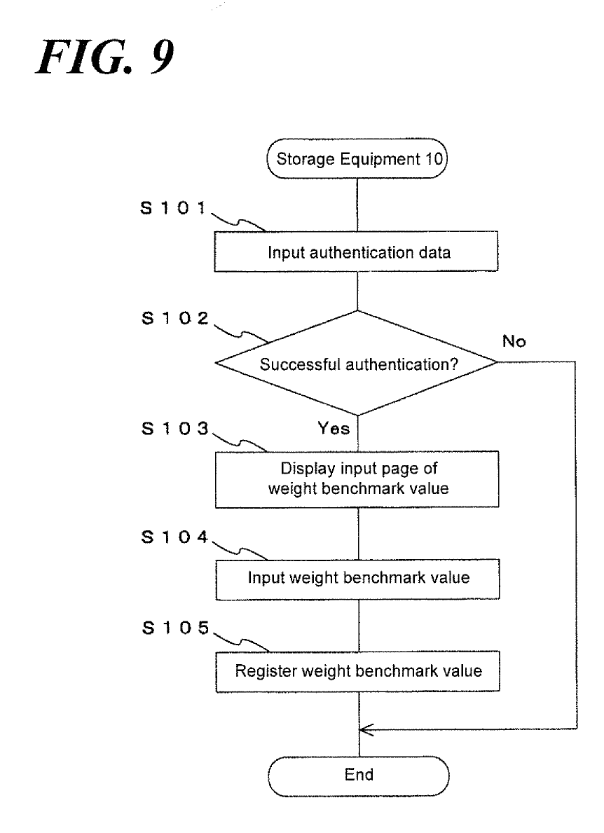

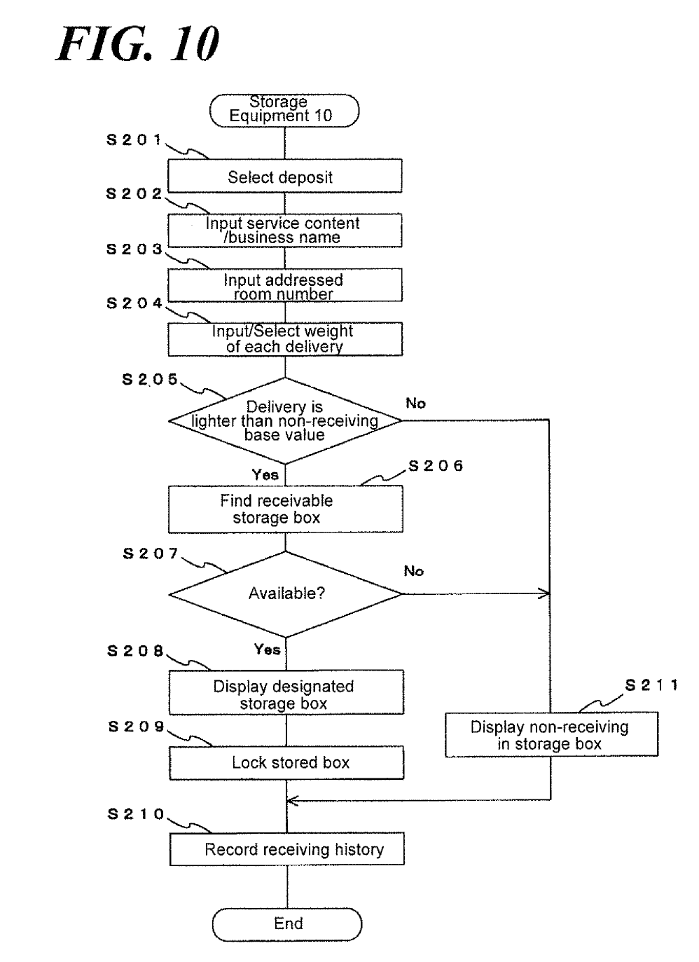

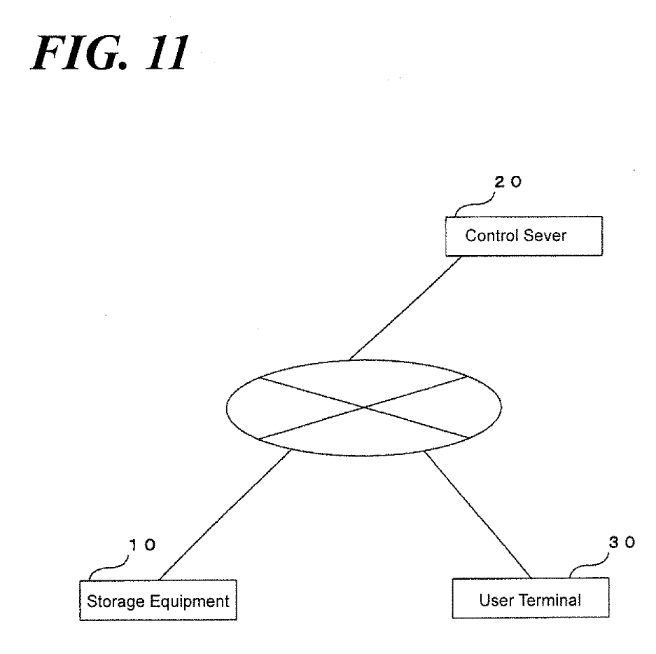

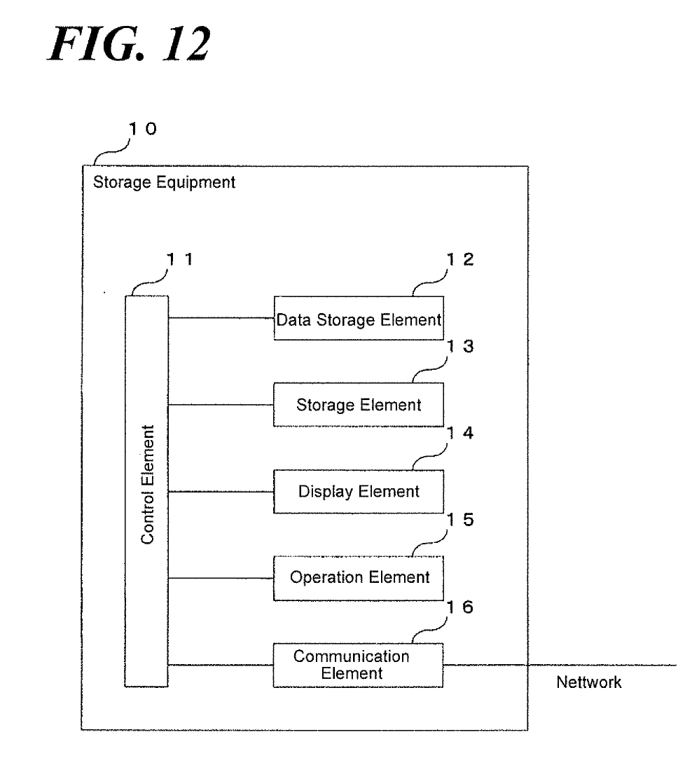

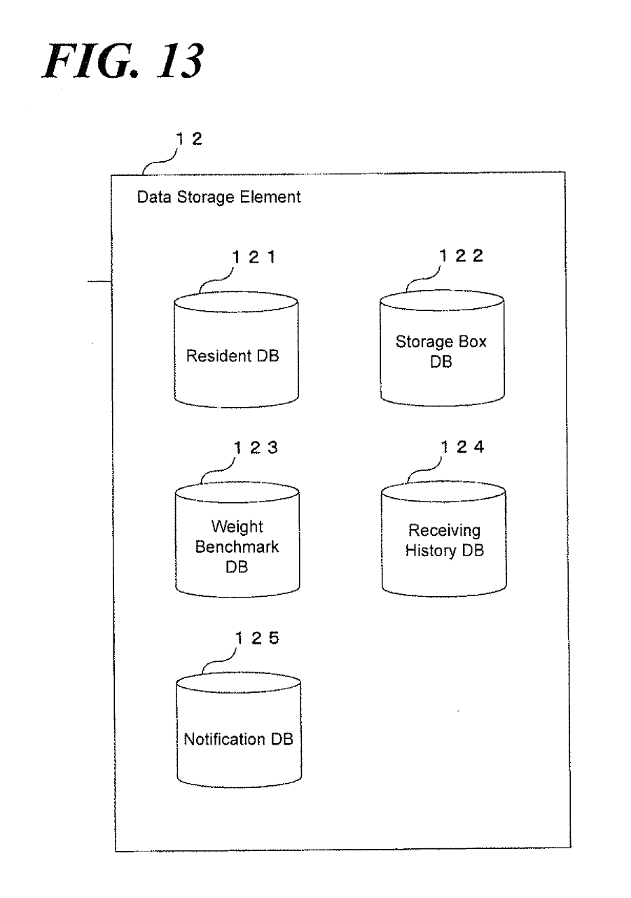

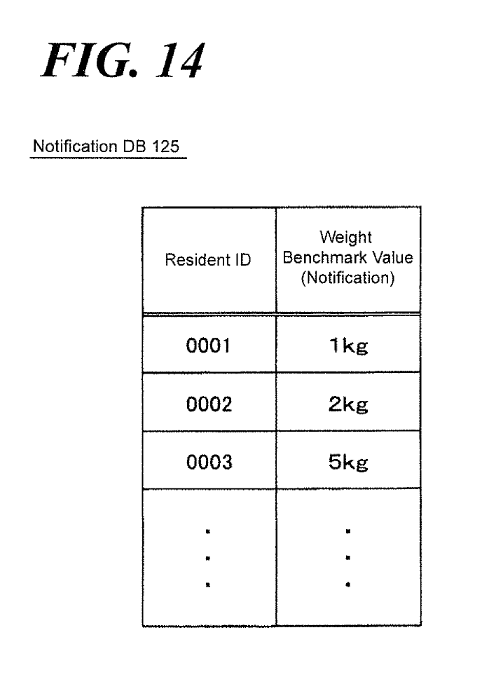

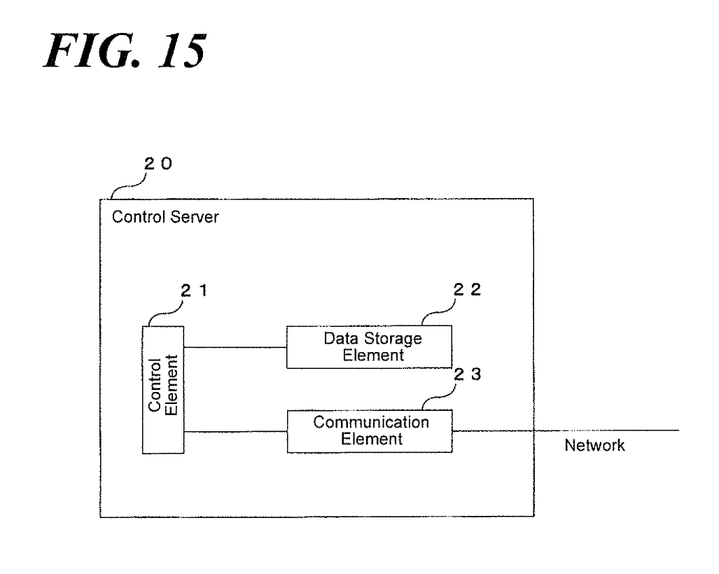

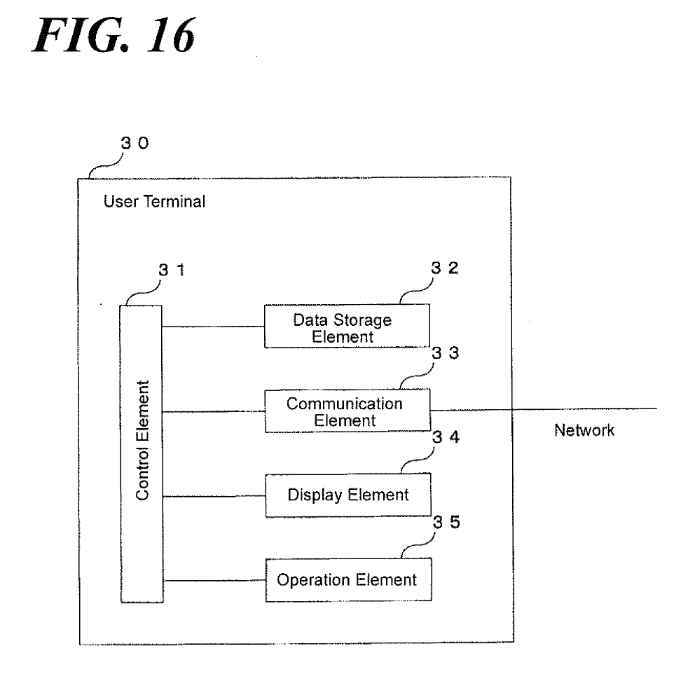

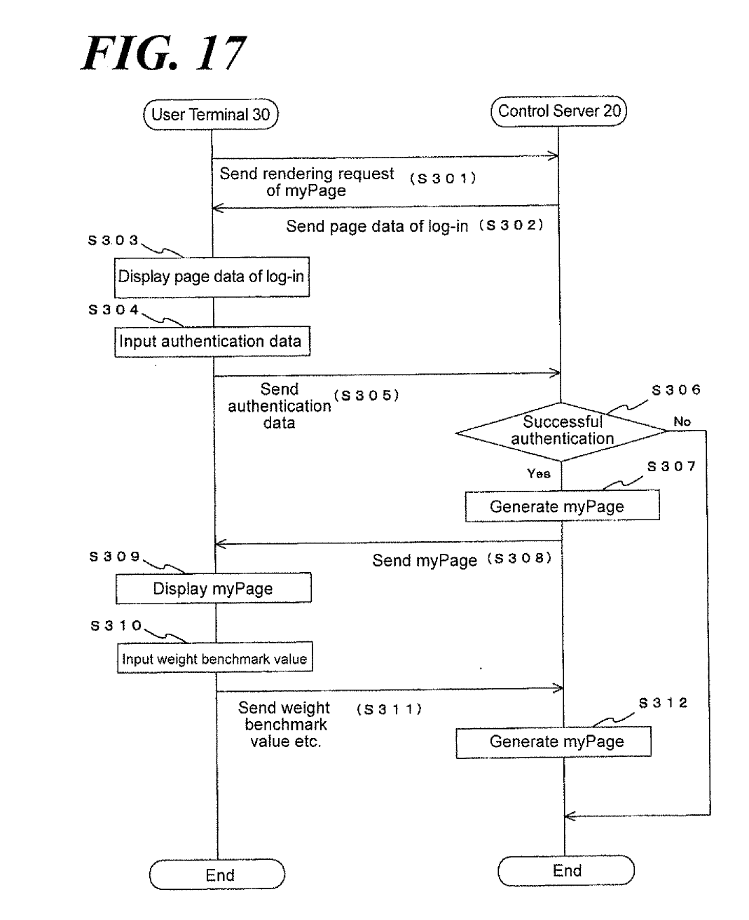

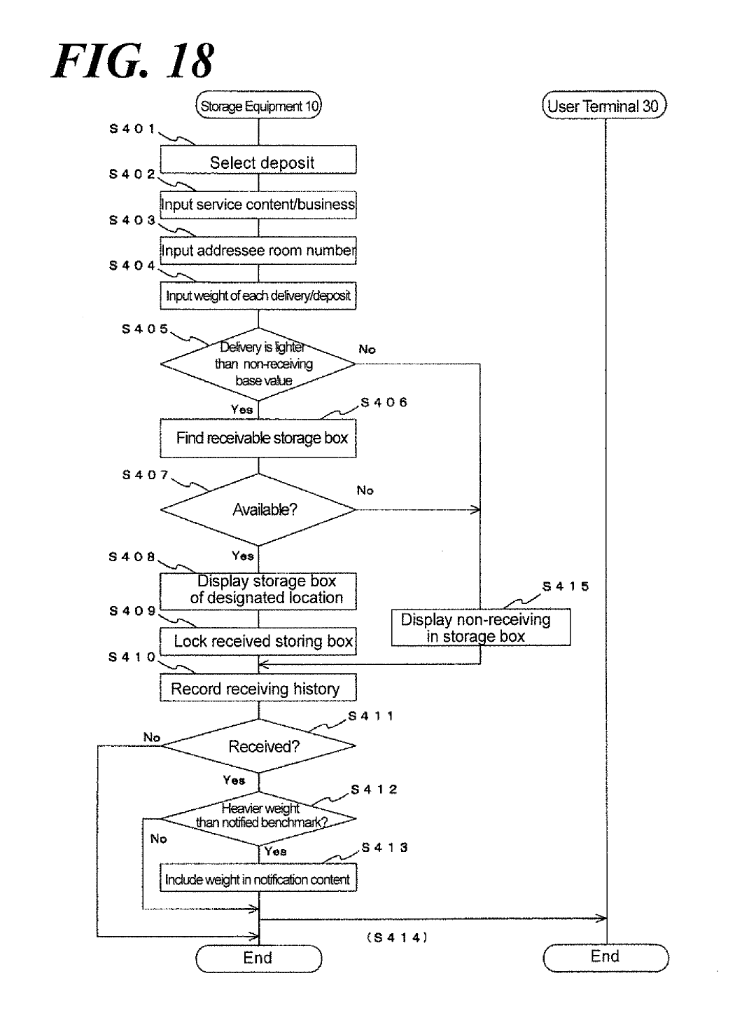

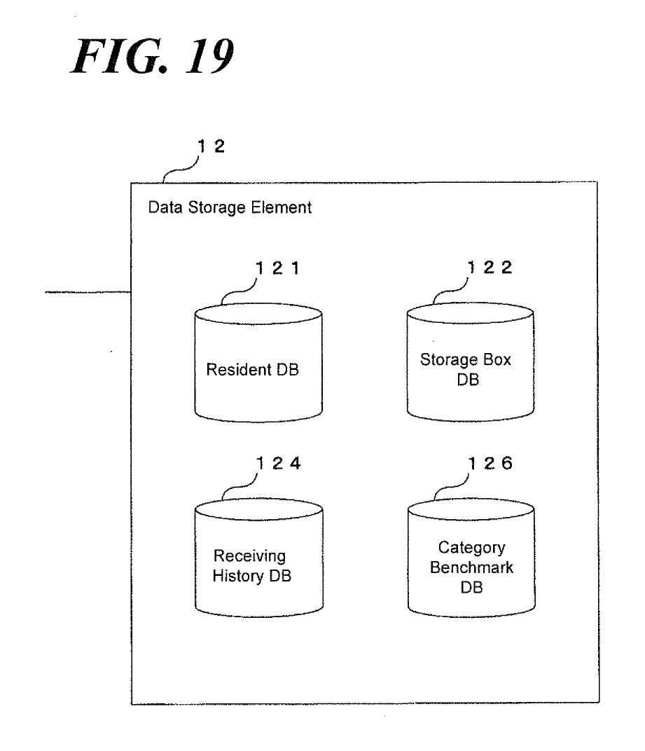

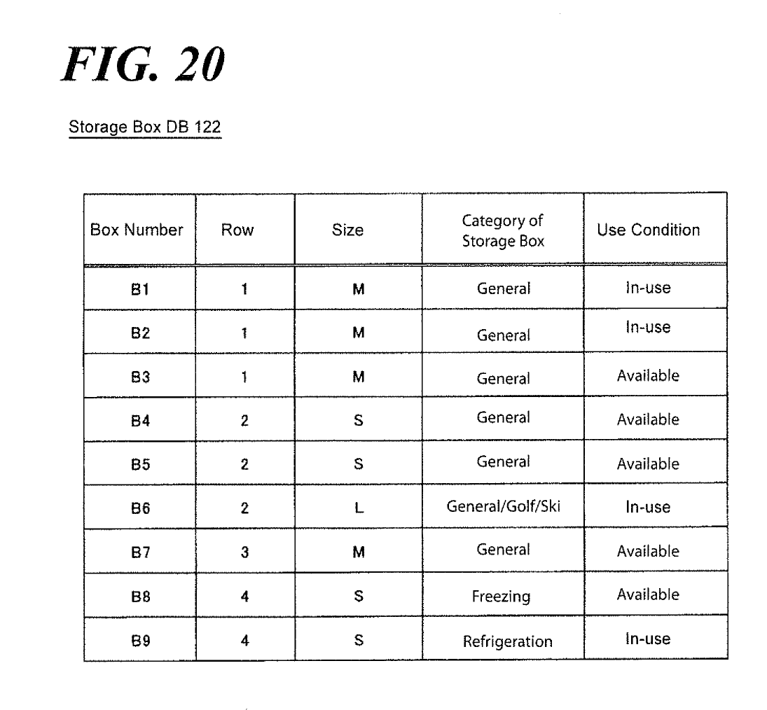

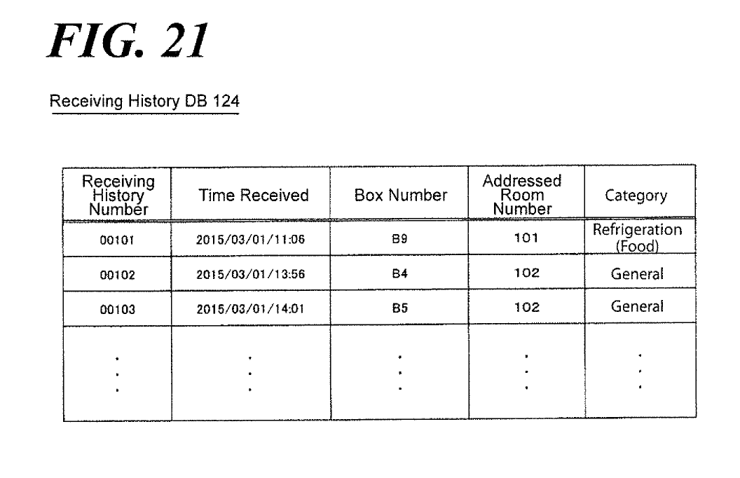

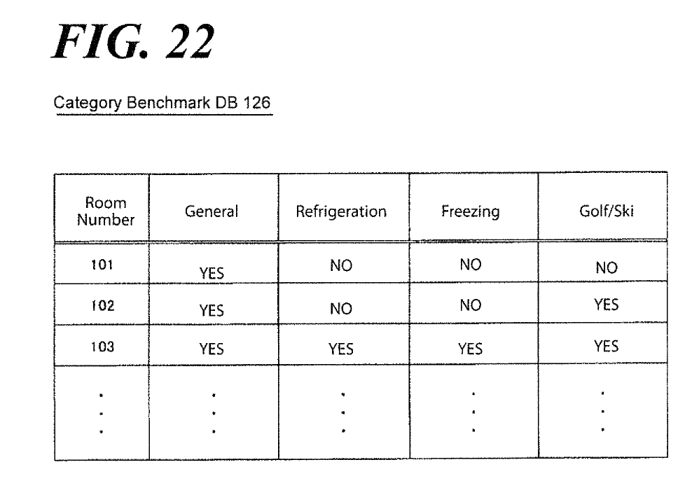

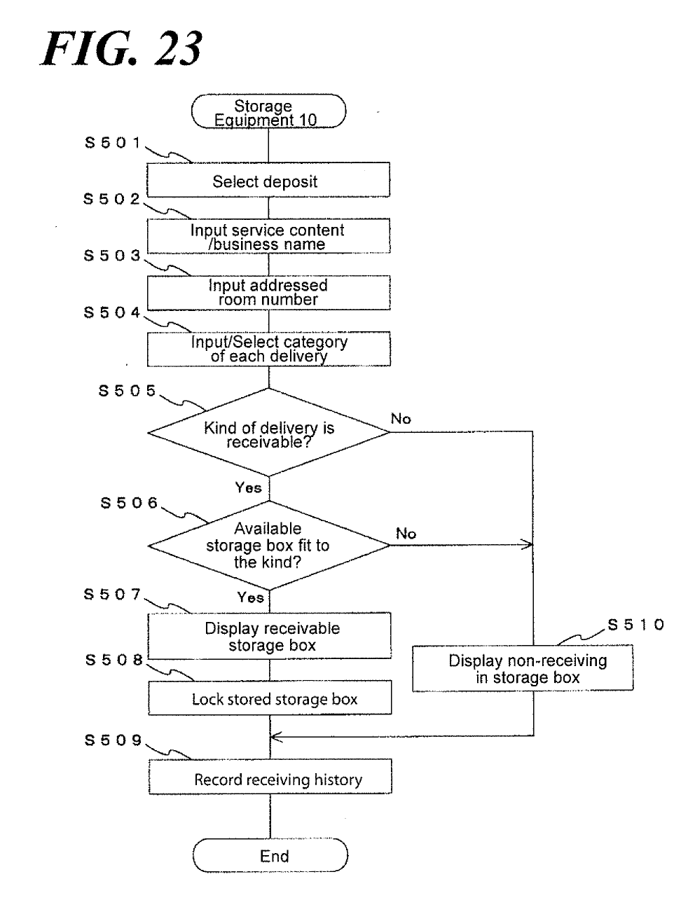

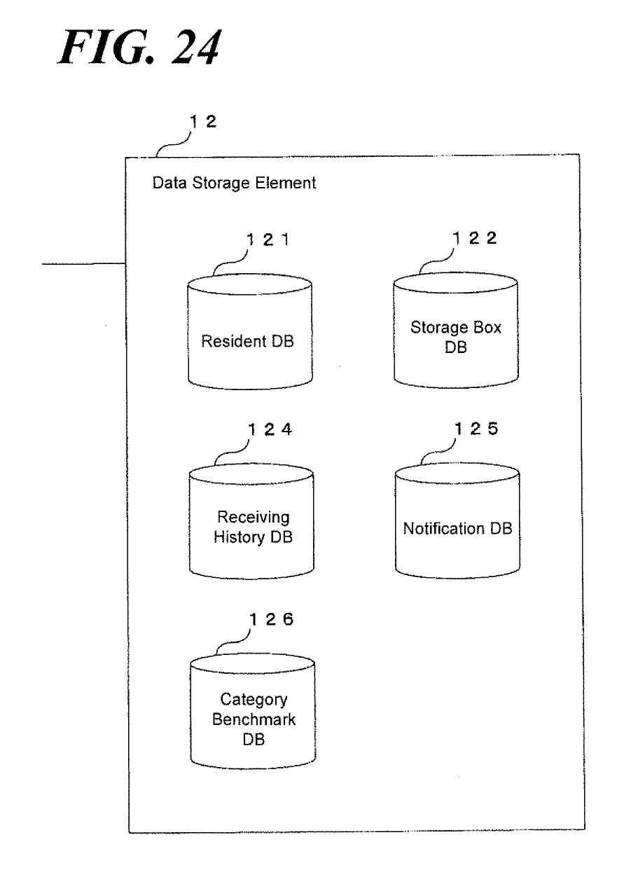

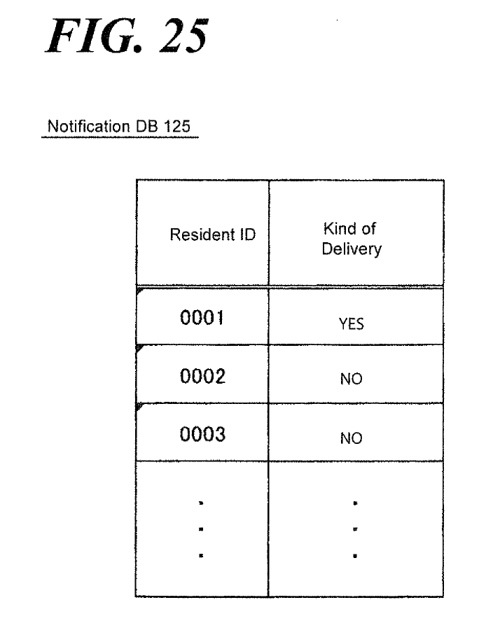

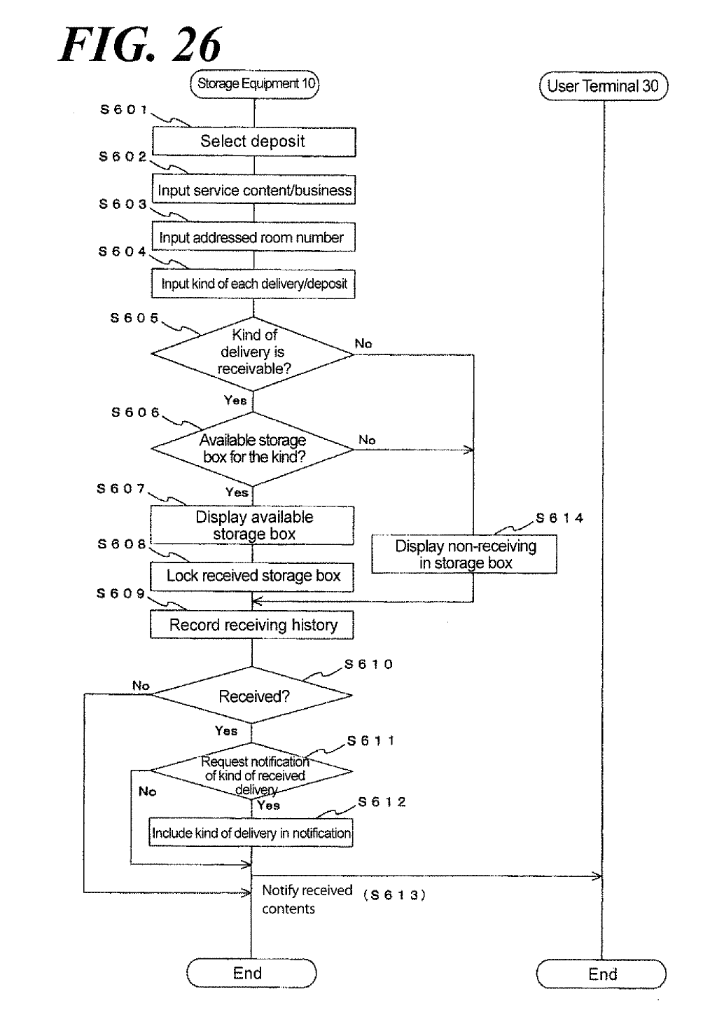

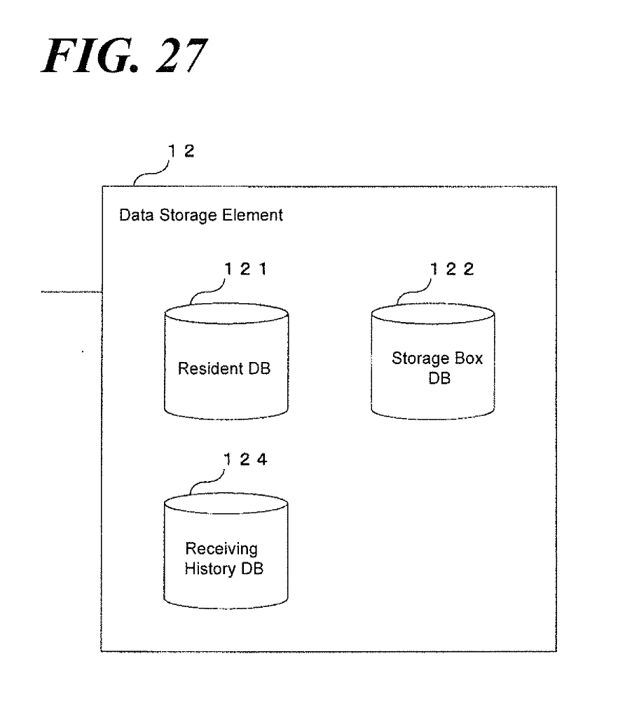

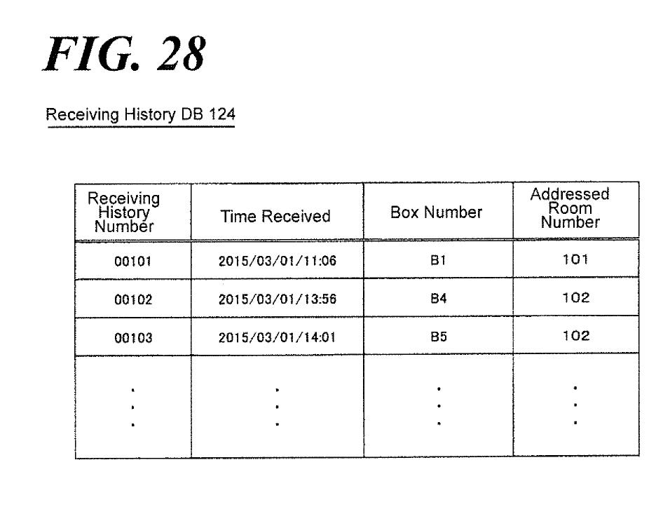

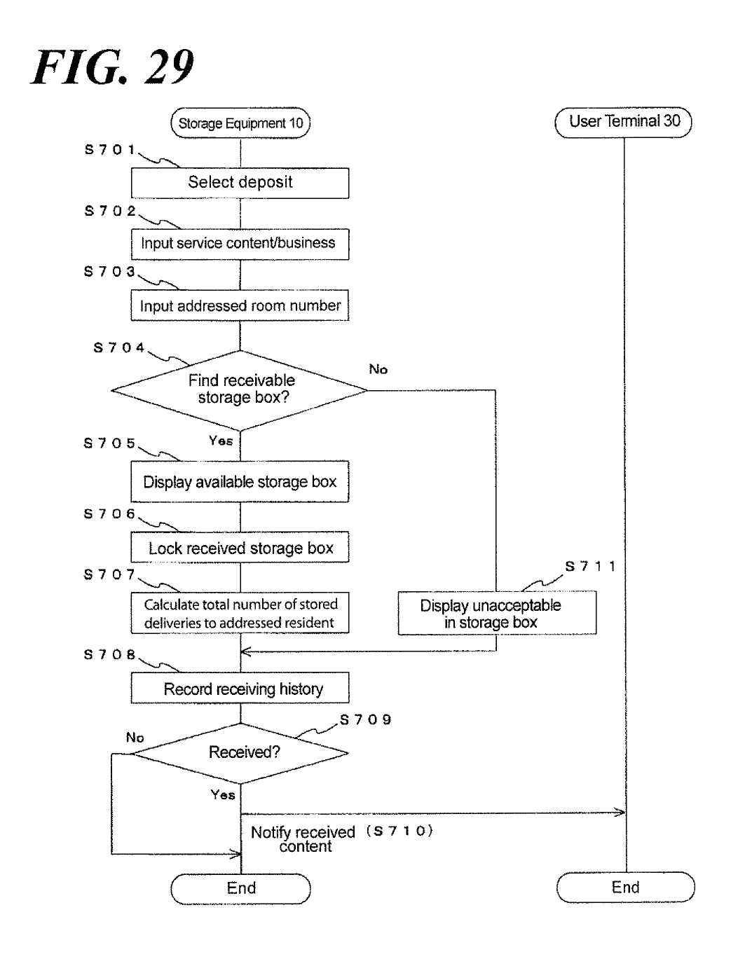

FIG. 1 is a perspective view of storage equipment of the aspect of the Embodiment 1 of the present invention.

FIG. 2 is a schematic diagram illustrating the structure of the storage equipment according to the aspect of the Embodiment 1 of the present invention.

FIG. 3 is a schematic diagram illustrating each database installed in the data storage element according to the aspect of the Embodiment 1 of the present invention.

FIG. 4 is a table illustrating the structure of a resident DB according to the aspect of the Embodiment 1 of the present invention.

FIG. 5 is a schematic diagram illustrating the location of the storage boxes of the storage element according to the aspect of the Embodiment 1 of the present invention.

FIG. 6 is a schematic diagram illustrating the data structure of the storage box DB according to the aspect of the Embodiment 1 of the present invention.

FIG. 7 is a schematic diagram illustrating the data structure of the weight benchmark DB according to the aspect of the Embodiment 1 of the present invention.

FIG. 8 is a schematic diagram illustrating the data structure of the receiving history DB according to the aspect of the Embodiment 1 of the present invention.

FIG. 9 is a schematic flow diagram illustrating the registration operation flow of the weight benchmark value according to the aspect of the Embodiment 1 of the present invention.

FIG. 10 is a schematic flow diagram illustrating the storing operation flow of the delivery relative to the storage equipment according to the aspect of the Embodiment 1 of the present invention.

FIG. 11 is a schematic diagram illustrating the structure of the goods storage system according to the aspect of the Embodiment 2 of the present invention.

FIG. 12 is a schematic diagram illustrating the structure of the storage equipment according to the aspect of the Embodiment 2 of the present invention.

FIG. 13 is a schematic diagram illustrating each database installed in the data storage element according to the aspect of the Embodiment 2 of the present invention.

FIG. 14 is a schematic diagram illustrating the data structure of a notice DB according to the aspect of the Embodiment 2 of the present invention.

FIG. 15 is a schematic diagram illustrating the structure of a control server according to the aspect of the Embodiment 2 of the present invention.

FIG. 16 is a schematic diagram illustrating the structure of the user terminal according to the aspect of the Embodiment 2 of the present invention.

FIG. 17 is a schematic flow diagram illustrating the registration operation flow of the weight benchmark value according to the aspect of the Embodiment 2 of the present invention.

FIG. 18 is a schematic flow diagram illustrating the storing operation flow of the delivery relative to the storage equipment according to the aspect of the Embodiment 2 of the present invention.

FIG. 19 is a schematic diagram illustrating each database installed in the data storage element according to the aspect of the Embodiment 3 of the present invention.

FIG. 20 is a schematic diagram illustrating the data structure of the storage box DB according to the aspect of the Embodiment 3 of the present invention.

FIG. 21 is a schematic diagram illustrating the data structure of the receiving history DB according to the aspect of the Embodiment 3 of the present invention.

FIG. 22 is a schematic diagram illustrating the data structure of the type benchmark DB according to the aspect of the Embodiment 3 of the present invention.

FIG. 23 is a schematic flow diagram illustrating the storing operation flow of the delivery relative to the storage equipment according to the aspect of the Embodiment 3 of the present invention.

FIG. 24 is a schematic diagram illustrating each database installed in the data storage element according to the aspect of the Embodiment 4 of the present invention.

FIG. 25 is a schematic diagram illustrating the data structure of a notification DB according to the aspect of the Embodiment 3 of the present invention.

FIG. 26 is a schematic flow diagram illustrating the storing operation flow of the delivery relative to the storage system according to the aspect of the Embodiment 4 of the present invention.

FIG. 27 is a schematic diagram illustrating each database installed in the data storage element according to the aspect of the Embodiment 5 of the present invention.

FIG. 28 is a schematic diagram illustrating the data structure of the receiving history DB according to the aspect of the Embodiment 5 of the present invention.

FIG. 29 is a schematic flow diagram illustrating the storing operation flow of the delivery relative to the storage system according to the aspect of the Embodiment 5 of the present invention.

### ASPECTS OF THE PREFERRED EMBODIMENTS

### Embodiment 1

### Summary of the Aspect of the Embodiment 1

The storage equipment 10, according to the aspect of the Embodiment 1, temporarily stores the goods being transferred from a user to another user in a storage box with a door that can be closed and locked.

The storage equipment 10 is capable of rejecting storing at all; or accepting storing the goods only in a storage box at a lower row, from which taking-out is much easier, when the goods is heavier than the predetermined weight so that the user can reduce the own labor to take out the goods from the storage box and then to carry the goods to the own residence.

Hereinafter, as an example, the inventor sets forth the practice; as that a user is the resident of a housing complex; the storage equipment 10 is installed in the common area, e.g., an entrance, of the housing complex, which is away from the residence of the housing complex in a predetermined distance or in the different floor; and the goods to be stored is a delivery being delivered by a delivery carrier, addressed to such resident.

### Structure of the Embodiment 1

### (1) Structure of the Storage Equipment 10

FIG. 1 is a perspective view of storage equipment 10 according to the aspect of the Embodiment 1 of the present invention.

The storage equipment 10 is configured as lockable to store the delivery for the resident and, for example, to function as a door-to-door delivery locker to temporarily store the delivery until the delivery would be delivered to the addresses.

According to the aspect of the Embodiment, as described above, as an example, the storage equipment 10 is installed in a common area of a housing complex.

In addition, as described later, the storage equipment may be installed in the housing complex such as an apartment, an office, a shop such as a convenient store or a supermarket, a commercial complex, or a public facility or an organization property such as a station and a hospital, but not limited thereto.

FIG. 2 is a schematic diagram illustrating the structure of the storage equipment 10 according to the aspect of the Embodiment 1 of the present invention.

Referring to FIG. 1, 2, the storage equipment 10 comprises; a control element 11 that controls the total storage equipment 10 including e.g., CPU and so forth, a data storage element 12 that stores a variety of data, a data storage element 13 that stores a variety of deliveries to the resident; an display element 14 displaying a variety of data; and an operation element 15 having a variety of keys is capable of inputting the data and conducts to read out the data for authentication written in the residential card and so forth, described later.

The storage element 13 comprises a plurality of storage boxes and each storage box thereof is configured to be lockable with a door. Basically, when no delivery is stored, the storage box is unlocked and the delivery is receivable. Once the delivery is received and stored, the door of the storage box is closed and the storage box is locked to store the delivery safe until the user of the delivery takes out.

In addition, the display 14 and the operation element 15 can be integrally configured to form a touch panel.

FIG. 3 is a schematic diagram illustrating each database 121-124 installed in the data storage element 12 according to the aspect of the Embodiment 1 of the present invention.

Referring to FIG. 3, the data storage element 12 stores; a resident DB 121 that controls the authentication data including such as the password needed for the resident to unlock the storage element 12; a storage box DB 122 that controls the location and the use condition of a plurality of storage boxes constituting the storage element 12; a weight benchmark DB 123 that controls the weight benchmark of the delivery when the delivery is rejected to be stored in the storage equipment 10 or the location of the storage box to be stored is designated; and a receiving history DB 124 that controls the receiving history relative to each storage box.

FIG. 4 is a table illustrating the data structure of the resident DB 121 according to the aspect of the Embodiment 1 of the present invention.

Referring to the example of FIG. 4, the resident DB 121 stores; a resident's name, a resident's room number, a password for authentication, an e-mail address, such resident's housing unit and the number of current deliveries stored in the storage equipment 10 are stored corresponding to an individual ID (resident ID) specifying the resident, respectively.

In addition, referring to the example of FIG. 4, the resident DB 121 controls the e-mail addresses as the data relative to the contact, the user terminal 30 described later and so forth, of the resident but the contact information is not limited thereto as far as the contact data. For example, an address of the mobile terminal and PC address and others e.g., the address of the intercom installed in each housing unit of the housing complex can be applied.

FIG. 5 is a schematic diagram illustrating the location of the storage boxes of the storage element 13 according to the aspect of the Embodiment 1 of the present invention.

FIG. 5 is further illustrating the location of the storage boxes B1-B9 constituting the storage element 13 of the storage equipment 10 referring to FIG. 1, 2.

Referring to the example of FIG. 5, the storage boxes B1-B9 are in-place in any one of 4 rows up-and-down. But the storage box B6 is crossing over the row 2 and the row 4 from the bottom.

FIG. 6 is a schematic diagram illustrating the data structure of the storage box DB 122 according to the aspect of the Embodiment 1 of the present invention.

According to the Embodiment referring to FIG. 6, the storage box DB 122 stores the location data indicating the row of each storage box, referring to FIG. 5, that is in-place in any one of 4 rows up-and-down, the storage capacity, and the current use condition (in-use or available), corresponding to the individual number (box number: B1-B9) identifying each storage box.

In addition, the storage box B6 that is crossing over the row 2 and the row 4 from the bottom is controlled as if in-place at the row 2 equal to the bottom of the storage box B6.

FIG. 7 is a schematic diagram illustrating the data structure of the weight benchmark DB 123 according to the aspect of the Embodiment 1 of the present invention.

According to the Embodiment referring to FIG. 7, a weight benchmark DB 123 stores the weight benchmark value (non-receiving) indicating the benchmark by which the delivery heavier than the predetermined weight is declined to be received and stored regardless all storage boxes, the weight benchmark value (designated receiving location) indicating the benchmark by which the delivery heavier than the predetermined weight can be accepted to be received and stored only in the designated storage box, and the location of the storage box available for receiving and storing at this time, corresponding to the resident ID identifying each resident.

Relative to the weight benchmark DB 123, for example, if the weight of the delivery addressed to the resident having the resident ID “0002” is 6 Kg, the storage equipment rejects to receive the delivery in any storage boxes because the weight thereof is heavier than the weight benchmark value that is “5 Kg” (non-receiving.)

In addition, relative to the weight benchmark DB 123, if the weight of the delivery addressed to the resident having the resident ID “0002” is 3 Kg, the storage equipment accepts to receive the delivery in any storage boxes because the weight thereof is lighter than the weight benchmark value that is “5 Kg” (non-receiving.)

Further, the weight of the delivery is heavier than “2 Kg”, which is the weight benchmark value (designated receiving location), so that the acceptable storage box to be received and stored can be limited.

Specifically, according to the Embodiment referring to FIG. 7, the designated receiving locations are “2 rows from the bottom” so that the storage equipment can accept to receive only into the storage box located at the bottom 2 rows (i.e., the storage boxes of B1-B6 of FIG. 7 but declines to receive in any boxes (i.e., storage boxes B7-B9) other than the designated boxes.

If all storage boxes B1-B6 at bottom 2 rows are in-use, once the delivery should be taken back, the delivery will be subject to redeliver.

FIG. 8 is a schematic diagram illustrating the data structure of the receiving history DB 124 according to the aspect of the Embodiment 1 of the present invention.

According to the example referring to FIG. 8, a receiving history DB 124 stores the time when the delivery was received and stored, the box number of the storage box therefor, the resident ID of the addressee resident of the delivery and the weight of the delivery, respectively corresponding to the receiving history number given in order of receiving and storing.

### Operation of the Aspect to the Embodiment 1

### (1) Operation to Set Up the Weight Benchmark Value

As described above, according to the weight benchmark DB 123, the weight benchmark value (non-receiving) and the weight benchmark value (designated receiving location) can be controlled. The resident or the person designated by the resident can register the weight benchmark value to the weight benchmark DB 123 by directly inputting thereto by operating the operation element 15 of the storage equipment 10.

FIG. 9 is a schematic flow diagram illustrating the registration operation flow of the weight benchmark value according to the aspect of the Embodiment 1 of the present invention.

Hereinafter, referring to FIG. 9, the inventor further sets forth the registration operation of the weight benchmark value (non-receiving/designate receiving location) described above.

Firstly, e.g., the resident goes to the installation location of the storage equipment 10 (e.g., a common area of the housing complex) and inputs the room number and the password of the resident per se by using the operation element 15 following the guidance menu displayed on the display element 14 of the storage equipment 10 (Step 101.)

At this step, the control element 11 of the storage equipment 10 determines whether the combination of the room number and the password above input are corresponding each other based on the registration in the resident DB 121 or not and proceeds the authentication (Step S102.)

At this step, when the control element 11 determines that the above combination thereof has not been registered (Step S102 is No), it is found that the authentication was failed and then the operation shall be over.

On the other hand, when the control element 11 finds that the above combination has been registered (Step S102 is Yes), it is found that the authentication was successful and then the input screen for the weight benchmark value shall be displayed on the display element 14 (Step S103.)

Then, e.g., the resident operates the ten key, the arrow key and so forth on the operation element 15 to input the above weight benchmark value (non-receiving/designate receiving location) respectively (Step S104.) At this step, for example, “2 Kg” as for the weight benchmark value (non-receiving) and “1 Kg” as for the weight benchmark value (designate receiving location) can be input.

The control element 11 registers the above weight benchmark values to the weight benchmark value DB 123 corresponding to the resident ID corresponded to the above room number in the resident DB 121 when the above weight benchmark value (non-receiving/designate receiving location (Step S105.)

The operation is now over.

Accordingly, the storage equipment 10 registers a weight benchmark value, which is the benchmark value to determine whether the delivery is subject to no-receiving or designation of receiving location, to the weight benchmark DB 123

The resident can revise once registered weight benchmark value by the same operation as the described above.

In addition, the resident can set and revise the own private information by directly operating the storage equipment 10 as the same as the operation of the weight benchmark value described above.

### (2) Storing Operation Relative to the Delivery

FIG. 10 is a schematic diagram illustrating the structure of the storage equipment 10 according to the aspect of the Embodiment 1 of the present invention.

Hereinafter, referring to FIG. 10, according to the aspect of the Embodiment, the inventor sets forth the operation relative to the storage equipment 10 when the delivery carrier delivers the delivery addressed to the resident of the housing complex.

Firstly, the delivery carrier attempts to deliver the delivery to a housing complex, and calls the addressed resident to notify that the resident has the delivery through the intercom in the common area or the door phone and makes sure if the resident is available or not.

At this time, when there is no answer from the resident and the resident is not available, the delivery carrier should visit the entrance hall of the housing complex, at which the storage equipment 10 is installed, to temporarily store the delivery addressed to the resident in the storage equipment 10.

Then, the delivery carrier selects “Deposit” by operating the operation element 15 on the selection page of the display element 14 of the storage equipment 10, on which “Deposit” or “Take-out” are displayed (Step S201.)

If “Deposit” is selected, the display element 14 shall display types of service content in accordance with the “Storing the delivery” or the list of businesses to provide the service therefor.

Then, the delivery carrier operates the operation element 15 to select the service content and the business name which are corresponding to the carrier per se (Step S202.)

Once the service content and the business name are selected, the display element retrieves the input page of the room number of the addressed housing complex.

Then, the delivery carrier makes sure such as e.g., a delivery bill for the delivery to be stored this time and then operates the operation element 15 to input the addressed room number (Step S203.)

Once the addressed room number is input, the display element 14 retrieves the input page of weight of the delivery to be stored this time.

Then, the door-to door delivery carrier operates the operation element 15 to input the weight of each delivery to be stored this time based on the input room number (e.g., addressed room number 101) described above (Step S204.)

At this time, referring to the resident DB 121, the control element 11 extracts the corresponded resident ID followed by the extraction of the weight benchmark value (non-receiving) (e.g., 2 Kg) of such resident (housing unit) based on the resident ID extracted in advance, referring to the benchmark weight DB 126, and then retrieves “Is the weight of the delivery heavier than 2 Kg?” in the weight input page described above so that the weight of the delivery can be input by selecting “Yes” or “No.”

As described above, once weight of the delivery is input, the control element 11 of the storage equipment 10 determines whether the weight of each delivery is heavier than the weight benchmark value (non-receiving) of each delivery or not (Step S205.)

If the weight of the delivery is heavier than the weight benchmark value (non-receiving) (Step S205 is No), the control element 11 displays the message indicating that there is no available storage box to receive such delivery (Step S211) on the display element 14 and instructs the delivery carrier not to store such delivery and then to proceed to the procedure of the Step S210.

On the other hand, the weight of the delivery is lighter than the weight benchmark value (non-receiving) (Step S205 is Yes), the control element 11 finds an available and receivable storage box without displaying the message indicating non-receiving into the storage box on the display element 14 (Step S206.)

At the Step S206, the control element 11 finds any storage box available for receiving based on the weight of the delivery input at the Step S204 referring to the weight benchmark DB 126.

Relative to the delivery addressed to the resident having ID “0002” (input room number is “306”), if the input weight of the delivery is 1 Kg, such weight is lighter than the weight benchmark value (designate storage location) so that all storage boxes B1-B9 can be retrieved as an available storage box for receiving.

Relative to the delivery addressed to the resident having ID “0002” (input room number is “0002”), if the input weight of the delivery is 3 Kg, such weight is heavier than the weight benchmark value (designating the storage location) so that storage boxes B1-B6 complying with designated receiving location “2 rows from the bottom” can be retrieved as an available storage box for receiving.

Next, the control element 11 determines whether the storage box found by the Step S206 is available or not (Step S207.)

If the control element 11 determines that no storage box is available (Step S207 is No), the control element 11 displays the message that indicates that there is no available storage box to receive such delivery (Step S211) and instructs the delivery carrier not to store such delivery and then to proceed to the procedure of the Step S210.

On the other hand, the control element 11 finds that the storage box found by the Step S206 is available (Step S207 is Yes), the control element 11 displays the location of such available and receivable storage box on the display element 14 (Step S208) and instructs the delivery carrier to store such delivery in the displayed relevant storage box.

Then, the delivery carrier stores the new delivery in the storage box displayed on the display element 14 and closes the door and then the control element 11 locks such occupied storage box (Step S209.)

Following the Step S209, the control element 11 generates the receiving history relative to receiving of the above delivery and records such receiving history in the receiving history DB 124 (Step S210.)

The receiving history to be recorded at this time includes the time when received, the storage box number, the housing unit number of the delivery address and the weight of the stored delivery and so forth, corresponding respectively to the receiving history number identifying each history. In addition, at this time, the control element 11 renews the current number of deliveries relative to the corresponding housing unit of the resident DB 121 by increasing the number of deliveries newly received.

On the other hand, following the Step S211, the control element 11 generates the receiving history relative to non-receiving of the delivery and records such receiving history in the receiving history DB 124 (Step S210.)

The receiving history to be recorded at this time includes the time when attempted to store, the housing unit number of the delivery address and the weight of the delivery that was attempted to be stored and so forth, corresponding respectively to the receiving history number identifying each history.

Then after, the resident comes up to the storage equipment 10 to take out the delivery addressed to the own hosing unit when the resident is informed by the delivery carrier via an e-mail or the home page of the website of the delivery carrier and so forth that the delivery was deposited in the storage equipment 10.

The operation is now over.

### Summary of the Embodiment 1

As set forth above, according to the aspect of the Embodiment 1 of the present invention, when the delivery carrier stores a delivery in the storage equipment 10 and inputs the weight of the delivery, the storage equipment 10 determines whether the weight of the delivery addressed to the housing unit is heavier than the weight benchmark value (non-receiving) or not, and if the delivery is too heavy for the resident to carry from the storage equipment 10 to the housing unit by oneself, the delivery carrier redelivers the delivery so that the resident does not have to prepare a dolly or something else all the way saving labor to go to take back and such labor therefor can be reduced.

In addition, according to the aspect of the present Embodiment, when the delivery carrier stores a delivery in the storage equipment 10 and the weight of the delivery is input, the storage equipment 10 determines whether the weight of the delivery addressed to the housing unit is heavier than the weight benchmark value (non-receiving) or not, and if the weight is lighter than the weigh benchmark value (designating the storage location) or heavier than the weight benchmark value (designating the storage location), an available storage box can be designated. Specifically, if the delivery is heavy, the storage equipment 10 designates only the storage box at the lower row to accept the receiving, from which the delivery can be easily taken out, so that it is restrained that the resident is too hard to take out the delivery because the storage box is in-place in the higher row and the resident can easily take out the delivery from the storage box.

Meantime, according to the aspect of the Embodiment 1 set forth above, when the weight of the delivery is input and the weight thereof is lighter than the weight benchmark value (non-receiving), the storage equipment 10 searches an available storage box without displaying an message and so forth, but instead, the storage equipment 10 may display an message to suggest storing in the storage box (e.g., at a few upper rows or the highest row) to which a light delivery can be also easily stored.

In addition, when the weight of the delivery is lighter than the weight benchmark value (non-receiving), for example, the storage box at the lower row (a lower few rows from the bottom or the bottom) can be locked as unavailable and the storage box at the upper row can be designated as available for the delivery carrier to store.

As described above, a relatively light delivery is guided to be stored in the storage box at the upper few rows so that the storage box at the lower row can be reserved as available for a heavy delivery.

In addition, according to the aspect of the Embodiment 1 set forth above, when the weight of the delivery is heavier than the weight benchmark value (designating storage location), only the specific storage box is capable of receiving but instead, the storage equipment 10 can designate the specific storage box available to receive without limitation.

For example, when the weight of the delivery is heavier than the weight benchmark value (designating storage location), the storage equipment 10 can display a message to instruct to store in the storage box at the few lower rows or the bottom row among available storage boxes or can unlock only the storage box at the few lower rows or the bottom row as available.

### Embodiment 2

### Summary of the Aspect of the Embodiment 2

A goods storage system according to the aspect of the Embodiment 2 of the present invention controls receiving per se and the storage location based on weight of the delivery as well as the storage equipment 10 according to the aspect of the Embodiment 1.

The goods storage system according to the aspect of the Embodiment 2 comprises a control server 20 that controls the information relative to the resident utilizing a temporary storage service for the delivery by the storage equipment 10 and a user terminal 30, which is a data processing device, operated by the above resident in addition to the storage equipment 10 according to the aspect of the Embodiment 1.

According to the aspect of the present Embodiment based on such structure, when received a delivery, the storage equipment 10 can send the package data, indicating the receiving, to the user terminal 30 for notification. The resident makes sure the data of the above package received and displayed by the user terminal 30 and then comes to the storage equipment 10 to take back the delivery addressed to oneself.

In addition, according to the aspect of the Embodiment 1, the resident per se comes to the location, where the storage equipment is installed, to operate the operation element 15 when the resident sets the weight benchmark value, but according to the aspect of the Embodiment 2, the resident can operates not only to run the setting method relative to the storage equipment 10, but also run the above setting by operating the user terminal 30 via the network 100.

Hereafter, unless otherwise specifically defined, the inventor further sets forth as the structures and the operations of the present Embodiment are the same as the Embodiment 1.

### Structure of the Aspect of the Embodiment 2

### (1) Entire Structure of the Goods Storage System

FIG. 11 is a schematic diagram illustrating the structure of the goods storage system according to the aspect of the Embodiment 2 of the present invention.

Referring to FIG. 11, the goods storage system comprises the storage equipment 10, the control server 20 that controls the information relative to the resident utilizing a temporary storage service for the delivery by the storage equipment 10 and the user terminal 30, which is a data processing device, operated by the above resident, which are connected via the network 100.

When the delivery was stored, the storage equipment 10 sends the package data thereof to the user terminal 30 to inform such receiving to the resident. At this time, the package data includes the weight of the delivery so that the resident being aware of the data can prepare any equipment such as a dolly to carry the delivery in advance when the delivery is heavy.

### (2) Structure of the Storage Equipment 10

FIG. 12 is a schematic diagram illustrating the structure of the storage equipment 10 according to the aspect of the Embodiment 2 of the present invention.

Referring to FIG. 12, the storage equipment 10 comprise; a control element 11 that controls the entire storage equipment 10 including e.g., CPU and so forth, a data storage element 12 that stores a variety of data, a data storage element 13 that stores a variety of deliveries to the resident; a display element 14 displaying a variety of data; an operation element 15 having a variety of keys is capable of inputting the data and conducts to read out the data for an authentication written in the residential card and so forth, described later, and a communication element 16 that conducts to send and receive the data via a connected network 100.

Accordingly, the storage equipment 10 according to the aspect of the present Embodiment comprises further the communication element 16 relative to the storage equipment 10 according to the aspect of the Embodiment 1.

According to the present Embodiment, the storage equipment 10 can send the data to and receive the data from the storage equipment 10 and the control server 20.

FIG. 13 is a schematic diagram illustrating each database 121-125 installed in the data storage element 12 according to the aspect of the Embodiment 2 of the present invention.

Referring to FIG. 13, the data storage element 12 stores; a resident DB 121 that controls the authentication data including such as the password needed for the resident to unlock the storage element 12; a storage box DB 122 that controls the location and the use condition of a plurality of storage boxes constituting the storage element 12; a benchmark weight DB 123 that controls the benchmark weight of the delivery when the delivery is rejected to be stored in the storage equipment 10 or the location of the storage box to be stored is designated; a receiving history DB 124 that controls the receiving history relative to each storage box; and a notification DB 125 that controls the benchmark to determine the content to be notified to the user terminal 30 every each resident (housing unit.)

Accordingly, the data storage element 12 according to the aspect of the Embodiment 2 of the present invention stores the notification DB 125 in addition to the structure of the data storage element 12 according to the aspect of the Embodiment 1.

FIG. 14 is a schematic diagram illustrating the data structure of the notification DB 125 according to the aspect of the Embodiment 2 of the present invention.

The notification DB 125 controls the benchmark (weight benchmark value) when a notification is sent to the resident relative to weight of the delivery.

According to the Embodiment referring to FIG. 14, the notification DB 125 stores the weight benchmark value (notification) defining the benchmark to send the notification relative to the package data to the addressed resident for such delivery when the delivery is heavier than the predetermined weight, corresponding to the individual ID (resident ID) identifying each resident.

For example, when the delivery of the addressed resident having the resident ID “0001” is heavier than 1 Kg, the storage equipment 10 writes the weight data relative to the above delivery on the package data notified to the resident

Further, according to the present Embodiment, the receiving history DB 124 controls also the weight of the stored delivery in addition to each term being controlled relative to the aspect of the Embodiment 1, corresponding to each receiving history number.

### (3) Structure of the Control Server 20

The control server 20 is a data processing device that is connected to the storage equipment 10 via the network 100 and controls the data relative to the storage of the delivery and so forth as well as the storage equipment 10.

FIG. 15 is a schematic diagram illustrating the structure of a control server 20 according to the aspect of the Embodiment 2 of the present invention.

Referring to FIG. 15, the control server 20 comprises a control element 21 having, e.g., CPU and so forth so as to control the entire control server 20; a data storage element 22 so as to store a variety of data; and a communication element 23 so as to send and receive the data via a network 100 to be connected.

The data storage element 22 stores the resident DB 221, the storage box DB 222, the weight benchmark DB 223, the receiving history DB 224 and the notification DB 225.

The data structure of such database 221-225 is respectively the same as each database 121-125 having the same name and stored in the storage equipment 10.

However, the resident DB 221 controls the private information of the resident (address, phone number and so forth) in addition to the data structure of the resident DB 121.

The control server 20 is connected to the terminal (e.g., PC and portable terminal not shown in FIG.) of the control business of the control server 20 via the network 100.

For example, when the control business receives the use registration relative to the services provided by the goods storage system via phone or fax and receives such user registration from the use terminal 30 by the control business terminal, the private information of the resident and the weight benchmark value given by the resident side upon above receiving are sent to the control server 20 and registered in each database 221-225 of the control server 20 by using the above control business.

In addition, the private information of the above resident and the weight benchmark value are changed, the control business sends the changed data content to the control server 20 through own terminal and then the control server changes the data controlled in each database 221-225 when received the data.

In addition, according to the aspect of the present Embodiment, not only the terminal of the above control business sets the private information and the weight benchmark value, but also as well as the aspect of the Embodiment 1 the resident can set up the private information and the weight benchmark value by directly operating the operation element 15 of the storage equipment 10.

In addition, the control server 20 stores the so-to-speak ‘myPage’ (which is a displayed personalized data page) relative to the available use function of the storage equipment 10, corresponding to the user ID of each resident, in the data storage element 22 and sends myPage from the user terminal following the request so that the data related to the delivery addressed to the housing unit of such resident can be provided.

Such myPage information is the displayed data of e.g., web page and so forth, which are assigned to each resident individually to use the temporary storage service for the delivery using the storage equipment 10, and only the designated each resident can retrieve the displayed data to browse by singing in with e.g., a password and so forth, in which the data of the delivery addressed to each resident or the current use condition of the storage equipment and so forth are displayed.

For example, the data relative to that the delivery addressed to the resident is stored or has been stored in the storage equipment, or that the delivery has not been received because of no available space in the storage box, specifically package data, are displayed in the my Page.

In addition, the weight of the delivery based on the above package data is displayed in such myPage.

The resident can make sure the weight of the delivery addressed to oneself, which is displayed in the myPage display presentation.

For example, if the myPage is a web page, the control server 20 is operative as a web server and sends the myPage to the user terminal 30 when rendering is requested.

In addition, the myPage can be stored in the storage equipment. In such case, the user terminal 30 sends a request to render the myPage to the storage equipment 10 and then receives the myPage.

According to the aspect of the present Embodiment, in addition to the methods by which the resident directly operates the storage equipment 10 to set up and the control business sets up from the terminal thereof, the resident can set up the weight benchmark value and private information.

The inventor sets forth the detail later.

In addition, the notification as to the weight of the delivery either received or not-received despite an attempt to be stored can be sent to the user side, and the inventor also sets forth later the detail of such method.

As to the above private information and the weight benchmark value, every setting or update or at the predetermined timing, the control server 20 sends the data in updated each database 221-225 therein to the storage equipment 10 and then the storage equipment 10 updates the data content in each database 121-125 stored in the storage equipment per se to the data content received from the control server 20 described above.

In addition, the control server 20 sends a query whether the private information and the weight benchmark value are set up or revised to the storage equipment 10 every setting or update or at the predetermined timing and then can synchronize between each database 121-125 and each database 221-225.

In addition, the storage equipment 10 sends the receiving history controlled by the receiving history DB 124 sends to the control server 20 every predetermined timing or according to a request from the control server 20 and so forth and the control server 20 records such receiving history in the receiving history DB 224 when received from the storage equipment 10.

The inventor skips the detail of the method of synchronization because such method is the same as a general method between a server and a terminal.

### (4) Structure of the User Terminal 30

The user terminal 30 is a data processing device operated by e.g., the resident of the housing complex, which can be an portable communication terminal including a smartphone, a mobile phone, PHS (personal handy-phone system) and PDA (personal digital assistant) and or a PC (personal computer) such as a tower computer, a desktop computer and a laptop computer.

FIG. 16 is a schematic diagram illustrating the structure of the user terminal 30 according to the aspect of the Embodiment 2 of the present invention.

Referring to FIG. 16, the user terminal 30 comprises a control element 31 having, e.g., CPU and so forth so as to control the entire user terminal 30; a data storage element 32 so as to store a variety of data; and a communication element 35 so as to send and receive the data via a network 100 to be connected; a display element 34 so as to display a variety of data; and an operation element 35 having a variety of keys so as to input such data

The resident can access the storage equipment 10 by using the user terminal 30 and can make sure the storage status of each storage box (e.g., the box number of the storage box, whether the delivery is stored or not, and the weight of the delivery and so forth.)

### Operation of the Aspect to the Embodiment 2

### (1) Operation to Set Up the Weight Benchmark Value

According to the aspect of the present Embodiment, the resident and so forth operates the operation element 15 of the storage equipment 10 to register the weight benchmark value in the weight benchmark DB 123 as well as the aspect of the Embodiment 1.

In addition to such way, according to the present Embodiment, the resident and so forth can register the weight benchmark value (non-receiving, designating receiving location and notification) in the weight benchmark DB 123 and the notification DB 125 via the network 100.

FIG. 17 is a schematic flow diagram illustrating the registration operation flow of the weight benchmark value according to the aspect of the Embodiment 2 of the present invention.

Hereinafter, referring to FIG. 17, the inventor further sets forth the registration operation of the weight benchmark value (non-receiving, designating receiving location, and notification) described above.

First, the resident and others send the rendering request of myPage to the control server by using the user terminal 30.

The control server 20 sends the display data as to the log-in page to myPage to the user terminal 30 when received the rendering request of the above myPage (Step S302.)

The user terminal 30 displays the display data as to the log-in page on the display element 34 when received such data (Step S303.)

For example, an input field of the resident ID or the room number of the resident and an input field of the password are displayed in the display data page for log-in.

Then, the resident operates the operation element 35 to input the required data in such input fields (Step S304.)

The user terminal 30 sends the above input data (resident ID, room number, password and so forth) to the control server 20 (Step S305.)

The control server 20 determines whether such data are corresponding each other based on the registration in the resident DB 221 or not and executes the authentication when received the input data from the user terminal 30 (Step S306.)

For example, at the Step S306, the control element 21 determines whether the room number and the password sent from the user terminal 30 are corresponding each other or not relative to the resident DB 221. Here, the control server 20 determines as the authentication is successful if corresponding each other and the authentication is failed if not corresponding each other.

Here, the control server 20 determines as the authentication is failed (Step S306 is No), the operation is over without sending myPage to the user terminal.

On the other hand, when the control server 20 determines as the authentication is successful (Step S306 is Yes), the predetermined terms are extracted from the each database 221-225 and then the myPage of the resident is generated (Step S307) and sent to the user terminal 30 (Step S308.)

Here, the data extracted from each database 221-225 are, for example, the name of the resident, the current status of the delivery addressed to the resident (e.g., in which the delivery is stored), the weight of the delivery and so forth, and such data are displayed on the myPage.

The user terminal 30 displays the myPage when received the myPage from the control server 20 (Step S309.)

Such myPage includes input fields to register or revise the weight benchmark value (non-receiving, designated receiving location and notification.)

Here, the resident inputs the above weight benchmark value in the input field of the above myPage by using the operation element 35. At this step, for example, “2 Kg” as for the weight benchmark value (non-receiving) and “1 Kg” as for the weight benchmark value (designate receiving location) can be input.

Then, the user terminal 30 sends the above input weight benchmark value along with the resident ID of the resident to the control server 20 (Step S311.)

The control server 20 registers the above weight benchmark value when received from the user terminal 30 in the weight benchmark DB 223 and the notification DB 225, corresponding to the resident ID that is received at the same time.

At this step, the operation to set up the weight benchmark value is over.

Then after, as described above, the control server 20 executes synchronization between the storage equipment 10 and each database and the weight benchmark value set in the myPage is reflected in the weight benchmark DB 123 value of the storage equipment.

Since, the storage equipment 10 rejects to receive, designates a storage box and reports the weight of the delivery to the user terminal 30 based on the input weight of the delivery when a delivery carrier stores the delivery in the storage equipment 10 and the above registered weight benchmark.

The resident can revise the once registered weight benchmark value by the same operation as the described above.

In addition, the resident can set up and revise the private information of oneself in the myPage by the same operation for the weight benchmark value described above.

### (2) Storing Operation Relative to the Delivery

FIG. 18 is a schematic flow diagram illustrating the storing operation flow of the delivery relative to the storage equipment according to the aspect of the Embodiment 2 of the present invention.

Hereinafter, referring to FIG. 18, according to the aspect of the Embodiment, the inventor sets forth the operation relative to the goods storage system when the delivery carrier delivers the delivery addressed to the resident of the housing complex.

The inventor skips the illustration of the Steps S401-S410, S415 illustrated in FIG. 18 because of the same as the Steps S201-S211 in FIG. 10.

After recording the receiving history (Step S410), the control element 11 of the storage equipment 10 determines whether the delivery was received or not (Step 411.)

When determined as not received (Step 411 is No), the operation is over.

On the other hand, when determined as the delivery was received (Step S411 is Yes), the control element 11 of the storage equipment 10, referring to the notification DB 125, determines whether the input weight at Step S404 is subject to notification or not (Step S412.)

Here, the control element 11 determines that the weight is subject to notification when the above input weight is heavier than the weight benchmark value (notification) (Step S412 is Yes), and decides that the weight data of the delivery should be included in the package data (Step S413.)

Then, the control element 11 generates the package data indicating that the delivery was received based on the above recorded receiving history and notifies the event to the user terminal of the resident.

The content of such notification can include that receiving of a delivery, the weight of the new delivery and the receiving storage box number and so forth.

On the other hand, the control element 11 determines that the weight is not subject to notification when the above input weight is lighter than the weight benchmark value (notification) (Step S412 is No), and generates the package data indicating that the delivery was received based on the above recorded receiving history and notifies the generated data, not including the weight data of the delivery, to the user terminal 30. (Step S414.)

The operation is now over.

### Summary of the Embodiment 2

As set forth above, according to the aspect of the Embodiment 2 of the present invention, when the delivery carrier stores a delivery in the storage equipment 10 and inputs the weight of the delivery, the storage equipment 10 determines whether the weight of the delivery addressed to the housing unit is heavier than the weight benchmark value (non-receiving) or not, and if the delivery is too heavy for the resident to carry from the storage equipment 10 to the housing unit by oneself, the delivery carrier redelivers the delivery so that the resident does not have to prepare a dolly or something else all the way saving labor to go to take back and such labor therefor can be reduced.

In addition, according to the aspect of the present Embodiment, when the delivery carrier stores a delivery in the storage equipment 10 and the weight of the delivery is input, the storage equipment 10 determines whether the weight of the delivery addressed to the housing unit is heavier than the weight benchmark value (non-receiving) or not, and if the weight is lighter than the weight benchmark value (designating the storage location) or heavier than the weight benchmark value (designating the storage location), an available storage box can be designated. Specifically, if the delivery is heavy, the storage equipment 10 allows only the storage box at the lower row to be stored, from which the delivery can be easily taken out, so that it is restrained that the resident is too hard to take out the delivery because the storage box is located in a higher row and the resident can easily take out the delivery from the storage box.

Further according to the aspect of the present Embodiment, when the delivery carrier stores a delivery in the storage equipment 10 and inputs weight of the delivery, the storage equipment 10 determines whether the delivery addressed to the unit is heavier than the weight benchmark value (notification), and if heavier than the weight benchmark value (notification), the fact is notified to the user terminal 30 of the addressed resident so that the resident can understand the weight of the delivery addressed to oneself in advance and make a preparation of e.g., loaning a dolly in advance when the resident comes to pick up the delivery.

Meantime, according to the aspect of the present Embodiment, the storage equipment 10 executes determining non-receiving or designating a storage location referring to the weight benchmark DB 123 when the weight data of the delivery is input, but any control equipment other than the storage equipment 10 can execute determining non-receiving or designating a storage location.

For example, if the above control equipment is the control server 20, when the weight data of the delivery is input, the storage equipment 10 sends the input data in addition to the also input resident ID to the control server 20.

When the control server 20 receives the weight data of the delivery and the resident ID, referring to the weight benchmark DB 223, the control server 20 determines whether non-receiving or designated storage location is applied relative to such delivery and sends the control signal based on the determined result to the storage equipment 10.

When the storage equipment 10 receives the above control signal from the control server 20, the storage equipment 10 executes non-receiving or designating the storage location corresponding to the content of the received control signal.

In addition, according to the aspect of the present Embodiment, the storage equipment 10 sends the package data to the user terminal 30, but the control server 20 can send the package data to the user terminal after synchronizing between the storage equipment 10 and the receiving history DB 124, 224 as described above.

In addition, as such notification method relative to the package data, in addition to e-mail, so-to-speak myPage, data review application (software) or SNS application (software) can be applied.

First, the inventor sets forth the method using the myPage to notify the package data.

As described above, when the resident activates the software to display the page data such as a browser by using the user terminal 30, sends the rendering request of myPage to the storage equipment 10 or the control server, the storage equipment 10 or the control server 20 sends the myPage to the user terminal 30 according to the rendering request thereof.

The user terminal 30 displays the myPage when received the myPage from storage equipment 10 or the control server 20. The package data including the weight data of the delivery is displayed in such myPage so that the resident can make sure the weight of the delivery by browsing such myPage.

In addition, the user terminal 30 can display the total number of deliveries on the display element 34 by installing the browsing application (software) to browse the page data of the package data.

After installing such application, the resident operates the operation element 35 to activate the above application and the user terminal 30 sends the rendering request of the package data to the storage equipment 10 or the control server 20, and then the storage equipment 10 or the control server 20 sends the package data to the user terminal 30 according to the rendering request thereof.

The user terminal 30 displays the package data when received the package data from storage equipment 10 or the control server 20.

In addition, the resident can acquire the package data by utilizing the application of SNS (software) installed in the user terminal 30.

In such case, the resident controls the storage equipment 10 or the control server 20 and adds a control business running the notification service of the above package data in the list as so-to-speak “tomodachi”, “friend” or “bookmark” so as to share the predetermined ID (e.g., user ID) between the resident and the control business.

Hereinafter, when a delivery is received or a delivery is rejected despite attempt of depositing, the storage equipment 10 or the control server 20 generates the package data and sends the package data to the user terminal 30 of the resident sharing above ID. At this time, the package data sent from the storage equipment or the control server 20 is once stored in the SNS operation server (not shown in FIG.) and then the user terminal can be configured to search in such SNS operation server to receive such package data.

When the user terminal 30 receives the package data from the storage equipment 10 or the control server 20, the user terminal 30 retrieves the package data thereof by using an e-mail service or a message board provided by SNS to display the package data on the display element 34.

As described above, the notification of the package data to the user terminal according to the aspect of the present Embodiment can be executed by using any available methods, including an e-mail, myPage or an application and so forth, but not limited thereto.

According to the aspect of the Embodiment 2, a goods storage system is configured to notify a delivery having heavier weight than the predetermined weight to the user terminal when the storage equipment 10 received so that the resident can prepare e.g., loaning a dolly to carry the delivery to the own housing unit from the storage equipment 10 in advance.

### Embodiment 3

### Summary of the Aspect of the Embodiment 3

According to the aspect of the above Embodiment 1, 2, when a delivery is heavy, receiving in the storage equipment 10 is rejected so that the resident can reduce own labor to carry the delivery from the storage equipment 10 to the own housing unit. In addition, when the delivery is heavier than the predetermined weight, the notification thereof is sent to the addressed resident so that the resident can be ready to go to pick up delivery at the storage equipment 10 with preparation e.g., preparing a dolly to carry the delivery in advance.

In contrast, according the aspect of the Embodiment 3 of the present invention, the storage equipment 10 can reject to receive in the specific storage box based on a type of the delivery and contents thereof so that a suitable way to transfer the delivery to the resident can be provided based on the type thereof and so forth. In addition, the type of the delivery and so forth are notified to the addressed resident so that the resident can prepare to go to the storage equipment 10 to pick up the delivery in advance.

Hereafter, unless otherwise specifically defined, the inventor further sets forth as the structures and the operations of the present Embodiment 3 are the same as the Embodiment 1.

### Structure of the Embodiment 3

### (1) Entire Structure

According to the aspect of the Embodiment 3 of the present invention, the storage equipment 10 is installed in e.g., an entrance hall of the housing complex and so forth as well as the aspect of the Embodiment 1.

Hereafter, the inventor sets forth the structure of the storage equipment 10 according to the aspect of the present Embodiment.

### (2) Structure of the Storage Equipment 10

FIG. 19 is a schematic diagram illustrating each database 121-126 stored in the data storage element 12 according to the aspect of the Embodiment 3 of the present invention.

Referring to FIG. 19, the data storage element 12 according to the present Embodiment controls the resident DB 121, the storage box DB 122, the receiving history DB 124 and the category benchmark DB 126.

Therefore, according to the present Embodiment, the data storage element 12 stores the category benchmark DB 126, which specifies whether receivable or unacceptable in the storage equipment 10 every resident based on such as a type of the delivery, instead of the weight benchmark DB 123 according to the Embodiment 1 of the present invention.

Hereinafter, the inventor sets forth in detail relative to the data structure of each database stored in the data storage element 12. However, the inventor skips an explanation of the data structure of the resident DB 121 because of the same aspect of the Embodiment 1.

FIG. 20 is a schematic diagram illustrating the data structure of the storage box DB 122 according to the aspect of the Embodiment 3 of the present invention.

Referring to FIG. 20, a storage box DB 122 according to the aspect of the present Embodiment controls each type of storage box in addition to the data controlled by the storage box DB 122 according to the aspect of the Embodiment 1.

The category of the storage box is the data indicating types of the delivery receivable in the storage box therefor. According to the aspect of the present Embodiment, the categories of the storage box include 4 categories e.g., “general”, “refrigeration”, “freezing”, and “golf/ski.”

The category of the storage box is “refrigeration”, the storage box has a refrigeration function so that the delivery, e.g., food, to be stored under refrigeration can be stored.

The category of the storage box is “freezing”, the storage box has a freezing function so that the delivery, e.g., food, to be stored under freezing can be stored.

The category of the storage box is “golf/ski”, the storage box has an enough space to store the long-length delivery such as golf clubs or skies.

If the category of the storage box is “general”, the storage box can store any delivery other than the delivery to be stored in the above storage boxes; “refrigeration”, “freezing”, and “golf/ski” (a delivery needs no refrigeration/no freezing and is not long.)

According to the example referring to FIG. 20, the category of the storage box B9 is “refrigeration” and currently in-use, i.e., the delivery to be stored under refrigeration is currently stored. No other storage box other than the storage box B9 is in the category of “refrigeration” so that no delivery can be stored in the storage equipment 10 even if the delivery that needs to be stored under refrigeration is newly delivered.

On the other hand, if a delivery that needs to be stored under freezing is delivered, the storage box B8 in the category of “freezing” is not-in-use “available” so that such delivery can be stored in the storage box B8.

FIG. 21 is a schematic diagram illustrating the data structure of the receiving history DB 124 according to the aspect of the Embodiment 3 of the present invention.

As set forth below, the receiving history DB 124 according to the aspect of the present Embodiment controls also any types of stored delivery (general, refrigeration, freezing, golf/ski and so forth) in addition to terms controlled in the receiving history DB 124 according to the aspect of the Embodiment 1 referring to FIG. 8.

According to the example referring to FIG. 21, the receiving history DB 124 stores the time when the delivery was received and stored, the box number of the storage box therefor, the resident ID of the addressed resident of the delivery and the type of the delivery, respectively corresponding to the receiving history number given in order of receiving and storing.

FIG. 22 is a schematic diagram illustrating the data structure of the category benchmark DB 126 according to the aspect of the Embodiment 3 of the present invention.

According to the example referring to FIG., the category benchmark DB 126 controls the data indicating whether receivable or unacceptable (hereinafter “category benchmark data”) in the storage equipment 10 relative to each category (general, refrigeration, freezing and golf/ski) of the delivery every each resident.

For example, the category benchmark data controlled by the category benchmark DB 126 referring to FIG., sets up as “YES” only if the category of the delivery addressed to the resident having the resident ID as “0001” is “general” and as receivable in the storage equipment 10. On the other hand, the delivery having the category, “refrigeration”, “freezing” and “golf/ski” is set as “NO” for rejection to receive in the storage equipment 10 and then should be directly delivered to the housing unit of the addressed resident.

### Operation of the Aspect to the Embodiment 3

### (1) Setting Operation of Category Benchmark Data

As described above, the category benchmark DB 126 controls the category benchmark data. The resident or the person designated by the resident can register the category benchmark value to the category benchmark DB 126 by directly inputting thereto by operating the operation element 15 of the storage equipment 10.

The inventor skips the detail explanation of the registration method of the category benchmark data because of the same registration method of the weight benchmark value referring to FIG. 9.

### (2) Storing Operation Relative to the Delivery

FIG. 23 is a schematic diagram illustrating the structure of the storage equipment 10 according to the aspect of the Embodiment 3 of the present invention.

Hereinafter, referring to FIG. 10, according to the aspect of the Embodiment, the inventor sets forth the operation relative to the storage equipment 10 when the delivery carrier delivers the delivery addressed to the resident of the housing complex.

Firstly, the delivery carrier attempts to deliver a delivery to a housing complex, and calls the addressed resident to notify that the resident has the delivery through the intercom in the common area or the door phone and makes sure if the resident is available or not.

At this time, when there is no answer from the resident and the resident is not available, the delivery carrier should visit the entrance hall of the housing complex, at which the storage equipment 10 is installed, to temporarily store the delivery addressed to the resident in the storage equipment 10.

Then, the delivery carrier selects “Deposit” by operating the operation element 15 on the selection page of the display element 14 of the storage equipment 10, on which “Deposit” or “Take-out” are displayed (Step S501.)

If “Deposit” is selected, the display element 14 shall display types of service content in accordance with the “Storing the delivery” or the list of businesses to provide the service therefor.

Then, the delivery carrier operates the operation element 15 to select the service content and the business name which are corresponding to the carrier per se (Step S502.)

Once the service content and the business name are selected, the display element retrieves the input page of the room number of the addressed housing complex.

Then, the delivery carrier makes sure such as e.g., a delivery bill for the delivery to be stored this time and then operates the operation element 15 to input the addressed room number (Step S503.)

Once the addressed room number is input, the display element 14 retrieves the input page of the category of the delivery to be stored this time.

Then, the door-to door delivery carrier operates the operation element 15 to input the kind of each delivery to be stored this time based on the input room number (e.g., addressed room number 101) described above (Step S504.)

For example, the category input page of such delivery displays the category icons of the delivery relative to “refrigeration”, “freezing” and “golf/ski” and the delivery carrier can select the relevant icon corresponding to the category of the receiving delivery this time.

As described above, once the category of the delivery is input, the control element 11 of the storage equipment 10 determines, referring to the category benchmark DB 126, whether the resident having the input room number is accepting the delivery belonging to the input category to be stored in the storage equipment 10 or not.

Relative to the Step S505, for example, when the room number input at the Step S503 is “306”, the control element 11 extracts the resident ID “0002” corresponding to the room number 306 referring to the resident DB 121 in FIG. 5.

Next, the control element 11 determines, referring to the category benchmark DB 126, whether the resident having the extracted resident ID “0002” is accepting the delivery belonging to the input category to be stored in the storage equipment 10 or not.

Here, if the input category of the delivery at the step S504 is “refrigeration”, the control element 11 determines that such delivery is rejected in the storage equipment 10 because the category benchmark DB 126 sets that the category “refrigeration” of the delivery is “NO” relative to the resident having the resident ID “0002.”

On the other hand, if the input category of the delivery at the step S504 is “golf/ski”, the control element 11 determines that such delivery is receivable in the storage equipment 10 because the category benchmark DB 126 sets that the category “golf/ski” of the delivery is “YES” relative to the resident having the resident ID “0002.”

If it is determined that the delivery of such category is unacceptable (Step S505 is No), the control element 11 displays the message indicating that all storage boxes are unavailable to receive such delivery (Step S510) on the display element 14 and instructs the delivery carrier not to deposit such delivery and then to proceed to the procedure of Step S509.

On the other hand, the delivery of such category is receivable (Step S505 is Yes), the control element 11 determines whether the available and receivable storage box without displaying the message indicating non-receiving into the storage box on the display element 14 (Step S506.)

At such Step S506, the control element 11 first finds any storage box available for receiving based on the type of the delivery input at the Step S504 referring to the storage box DB 122 of FIG. 18.

For example, if the category of such delivery is “golf/ski”, the control element 11 finds the storage box B6 including “golf/ski” in the “category of the storage box” in the storage box DB 122. Then, the control element 11 determines that no receivable storage box is available because only the storage box B6 is receivable “golf/ski” delivery and currently in-use.

On the other hand, if the category of such delivery is “general”, the control element 11 finds the storage box B1-B7 including “general” in the “category of the storage box” in the storage box DB 122. Then, the control element 11 searches the use status of such storage box B1-B7 and consequently determines that a storage box is available for the delivery of such category because storage boxes B3, B4, B5 and B7 are “available”.

If the control element 11 determines that the storage box found by the Step S506 is available (Step S506 is Yes), the control element 11 displays the location of such available and receivable storage box on the display element 14 (Step S507) and instructs the delivery carrier to store such delivery in the displayed relevant storage box.

Then, the delivery carrier stores the delivery in the storage box displayed on the display element 14 and closes the door and then the control element 11 locks such occupied storage box (Step S508.)

On the other hand, if the control element 11 determines that no storage box is available (Step S506 is No), the control element 11 displays the message that indicates that there is no available storage box to receive such delivery (Step S510) and instructs the delivery carrier not to store such delivery and then to proceed to the procedure of Step S509.

Following the Step S508, the control element 11 generates the receiving history relative to receiving of the above delivery and records such receiving history in the receiving history DB 124 (Step S509.)

The receiving history to be recorded at this time includes the time when received, the storage box number, the housing unit number of the delivery address and the type of the stored delivery and so forth, corresponding respectively to the receiving history number identifying each history.

On the other hand, following the Step S510, i.e., in the case of that the delivery was not received, the control element 11 generates the receiving history relative to receiving of the above delivery and records such receiving history in the receiving history DB 124 (Step S509.)

The receiving history to be recorded at this time includes the time when attempted to store, the housing unit number of the delivery address and the category of the delivery that was attempted to be stored and so forth, corresponding respectively to the receiving history number identifying each history.

The operation is now over.

### Summary of the Embodiment 3

As set forth above, according to the aspect of the Embodiment 3 of the present invention, when the delivery carrier stores a delivery in the storage equipment 10 and inputs the type of such delivery, the storage equipment 10 determines whether the delivery of e.g., such type is acceptable or not, and if not acceptable, displays non-receiving so that the delivery carrier redelivers to the addressed resident without storing the delivery in the storage equipment 10 depending on the type of the delivery when the addressed resident is not available, and the resident can easily and directly receive the delivery that the resident does not want to be stored temporarily in the storage equipment 10, accordingly.

For example, when the resident wants to receive the delivery needed to be refrigerated directly without storing in the storage equipment 10, the resident sets as such way relative to the category benchmark data so that the resident can receive the delivery as requested.

### Embodiment 4

### Summary of the Aspect of the Embodiment 4

A goods storage system according to the aspect of the Embodiment 4 of the present invention controls the storage based on the type of the delivery as well as the storage equipment 10 according to the aspect of the Embodiment 3.

The goods storage system according to the aspect of the Embodiment 4 of the present invention comprises a control server 20 that controls the data relative to the resident utilizing a temporary storage service for the delivery by the storage equipment 10 and a user terminal 30, which is a data processing device, operated by the above resident in addition to the storage equipment 10 according to the aspect of the Embodiment 3 as well as the as the aspect of the Embodiment 2.

According to the aspect of the present Embodiment based on such structure, when received a delivery, the storage equipment 10 sends the package data, indicating the receiving, to the user terminal 30 for notification.

The resident makes sure the data of the above package received and displayed by the user terminal 30 and then comes to the storage equipment 10 to take back the delivery addressed to oneself.

In addition, according to the aspect of the Embodiment 3, the resident per se comes to the location, where the storage equipment is installed, to operate the operation element 15 when the resident sets the category benchmark data, but according to the aspect of the Embodiment 4, the resident can operates not only to run the setting method relative to the storage equipment 10, but also run the above setting by operating the user terminal 30 via the network 100.

Hereafter, unless otherwise specifically defined, the inventor further sets forth as the structures and the operations of the present Embodiment are the same as the Embodiment 3.

### Structure of the Aspect of the Embodiment 4

### (1) Entire Structure of the Goods Storing System

The goods storage system according to the aspect of the Embodiment 4, as well as the aspect of the Embodiment 4, comprises the storage equipment 10, the control server 20 that controls the data relative to the resident utilizing a temporary storage service for the delivery by the storage equipment 10 and the user terminal 30, which is a data processing device, operated by the above resident, which are connected via the network 100 and the structure is the same as the structure of the goods storage system according to the aspect of the Embodiment 2 of the present invention referring to FIG. 11.

When the delivery is stored, the storage equipment 10 sends the package data thereof to the user terminal 30 to inform such receiving to the resident. At this time, the package data includes the category (needs refrigeration, needs freezing, golf, ski and so forth) of the delivery so that the resident being aware of the data can prepare to have a cool-pack or a dolly to carry the delivery in advance.

### (2) Structure of the Storage Equipment 10

In addition to the structure of the storage equipment 10 according to the aspect of the Embodiment 3, the storage equipment 10 according to the aspect of the Embodiment 4 further comprises additionally a communication element 16 that sends and receives between the control server 20 and the user terminal 30 via a network 100, and is the same as the structure of the storage equipment 10 according the aspect of the Embodiment 2 referring to FIG. 12.

FIG. 24 is a schematic diagram illustrating each database 121-126 stored in the data storage element 12 according to the aspect of the Embodiment 4 of the present invention.

Referring to FIG. 13, the data storage element 12 stores; a resident DB 121 that controls the authentication data including such as the password needed for the resident to unlock the storage element 12; a storage box DB 122 that controls the location and the use condition of a plurality of storage boxes constituting the storage element 12; a receiving history DB 124 that controls the receiving history relative to each storage box; a notification DB 125 that controls the benchmark to determine the content to be notified to the user terminal 30 every each resident (housing unit); and a category benchmark DB 126 that specifies receivable or unacceptable in the storage equipment 10 according to the category of the delivery and so forth.

Accordingly, the data storage element 12 according to the aspect of the Embodiment 4 of the present invention stores the notification DB 125 in addition to the structure of the data storage element 12 according to the aspect of the Embodiment 3.

FIG. 25 is a schematic diagram illustrating the data structure of the notification DB 125 according to the aspect of the Embodiment 3 of the present invention.

Referring to FIG. 14, while the notification DB 125 controls the benchmark (weight benchmark value) when a notification is sent to the resident relative to the weight of the delivery, according to the aspect of the present Embodiment, the notification DB 125 controls whether the notification is executed or not according to the content of the delivery.

According to the Embodiment referring to FIG. 25, when the delivery is stored in the storage equipment 10, the notification DB 125 stores the “category of the delivery” indicating whether the category of the delivery must be given to the package data of the delivery, which is sent to the addressed user, or not, corresponding to the individual ID (resident ID) identifying each resident.

For example, referring to FIG. 25, the resident having the resident ID that is “0001” is controlled as “YES” for “category of the delivery” in the notification DB 125, the package data of the delivery addressed to such resident in the category of the delivery can include e.g., needs refrigeration, needs freezing, golf, ski and so forth.

On the other hand, the resident having the resident ID that is “0002” is controlled as “NO” for “category of the delivery”, the package data of the delivery addressed to such resident is not required to provide the category of the delivery and noting is provided, accordingly.

### (3) Structure of the Control Server 20

The control server 20 according to the aspect of the Embodiment 4 of the present invention comprises the resident DB 221, the storage box DB 222, the receiving history DB 225, the notification DB 226, and the category benchmark DB 226.

The structure of the data of each database 221-226 is respectively the same as each data benchmark 121-126 having the same name and stored in the storage equipment 10.

The inventor skips an explanation of synchronization method between each database 221-226 of the control server 20 and each database 121-126 because of the same aspect of the Embodiment 2.

### Operation of the Aspect to the Embodiment 4

### (1) Setting Operation of Category Benchmark Data

As described above, the category benchmark DB 126 controls the category benchmark data. The resident or the person designated by the resident can register or revise the category benchmark value in the category benchmark DB 126 by directly inputting thereto by operating the operation element 15 of the storage equipment 10.

The inventor skips the detail explanation of the registration and revising methods of the category benchmark data because of the same registration method of the weight benchmark value referring to FIG. 9 (the same aspect of the Embodiment 3.)

In addition, the category benchmark data can be set up or revised via the terminal of the control business or in the myPage. The inventor also skips the explanation thereof because it is the same as that the weight benchmark value according to the aspect of the Embodiment 2 is replaced by the category benchmark data.

In addition, the private information can be also set up or modified as well as the aspect of the Embodiment 2.

### (2) Storing Operation Relative to the Delivery

FIG. 26 is a schematic flow diagram illustrating the storing operation flow of the delivery relative to the storage system according to the aspect of the Embodiment 4 of the present invention.

Hereinafter, referring to FIG. 26, according to the aspect of the Embodiment, the inventor sets forth the operation relative to the goods storage system when the delivery carrier delivers the delivery addressed to the resident of the housing complex.

The inventor skips the illustration of the Steps S601-S609, S614 illustrated in FIG. 26 because of the same as the Steps S501-S510 referring to FIG. 23.

After recording the receiving history (Step S609), the control element 11 of the storage equipment 10 determines whether the delivery was received or not (Step 610.)

When determined as not received (Step 610 is No), the operation is over.

On the other hand, when it is determined that the delivery was received (Step S610 is Yes), the control element 11 of the storage equipment 10, referring to the notification DB 125, determines whether the resident who is receiving the delivery is requesting the notification relative to the type of the delivery or not (Step S611.)

Here, the control element 11 determines, relative to the notification DB 125, that the resident is requesting to get the notification of the type of the delivery (Step S611 is Yes), and decides that the package data should include the data relative to the type of the delivery (Step S612.)

Then, the control element 11 generates the package data indicating that the delivery was received based on the above recorded receiving history and sends the notification to the user terminal 30 of the resident.

The content of such notification can include that receiving of a delivery, the type of the new delivery and the receiving storage box number and so forth.

On the other hand, the control element 11 determines that the resident is not requesting to get the notification relative to the type of the delivery (Step S611 is No), and generates the package data indicating that the delivery was received based on the above recorded receiving history and notifies the generated data, not including the data relative to the type of the delivery, to the user terminal 30. (Step S613.)

The operation is now over.

### Summary of the Embodiment 4

As set forth above, according to the aspect of the Embodiment 4 of the present invention, when the delivery carrier stores a delivery in the storage equipment 10 and inputs the type of such delivery, the storage equipment 10 determines whether the delivery of e.g., such type is acceptable or not, and if not acceptable, displays non-receiving so that the delivery carrier redelivers to the addressed resident without storing the delivery in the storage equipment 10 depending on the type of the delivery when the addressed resident is not available, and the resident can easily and directly receive the delivery that the resident does not want to be stored temporarily in the storage equipment 10, accordingly.

In addition, according to the aspect of the present Embodiment, when the delivery carrier is going to store the delivery in the storage equipment 10, whether received or not-received and the type of the delivery are notified to the user terminal 30 of the addressed resident so that, for example, the resident can easily understand that the delivery addressed to oneself needs to be refrigerated and can go earlier to pick up the delivery to the storage equipment 10 or can arrange to redelivery and therefore the resident can receive the delivery at the best timing.

Meantime, according to the aspect of the present Embodiment, the storage equipment 10 executes determining non-receiving referring to the category benchmark DB 126 when the data relative to the type of the delivery is input, but any control equipment other than the storage equipment 10 can be configure to control non-receiving.

For example, if the above control equipment is the control server 20, when the data relative to the type of the delivery is input, the storage equipment 10 sends the input data in addition to the also input resident ID to the control server 20.

When the control server 20 receives the data relative to the type of the delivery and the resident ID, referring to the category benchmark DB 227, the control server 20 determines whether non-receiving or designating a storage location is applied relative to such delivery and sends the control signal based on the determined result to the storage equipment 10.

When the storage equipment 10 receives the above control signal from the control server 20, the storage equipment 10 executes non-receiving corresponding to the content of the received control signal.

As described above, the notification of the package data to the user terminal 30 according to the aspect of the present Embodiment can be executed by using any available methods, including an e-mail, myPage or an application for browsing and so forth, but not limited thereto.

The inventor skips an explanation of the notification method of the package data because of the same aspect of the Embodiment 2.

### Embodiment 5

### Summary of the Aspect of the Embodiment 5

A goods storage system according to the Embodiment 5 of the present invention comprises storage equipment 10, a control server 20, a user terminal 30 as well as in the aspect of the Embodiment 4.

According to the present Embodiment, when the notification of receiving or non-receiving is sent to the resident side, the total number of current deliveries addressed to the resident is also notified together.

Hereafter, unless otherwise specifically specified, the inventor sets forth as the structures and the operations of the present Embodiment are the same as the aspect of the Embodiment 4.

### Structure of the Aspect of the Embodiment 5

### (1) Entire Structure of the Goods Storing System

As set forth above, the goods storage system according to the Embodiment 5 of the present invention comprising; as well as the aspect of the Embodiment 2 or the Embodiment 4, the storage equipment 10 that receives the delivery temporally; the control server 20 that controls the data relative to the resident utilizing a temporary storage service for the delivery by the storage equipment 10; and the user terminal 30, which is a data processing device, operated by the above resident, which are connected via the network 100; is the same structure of the goods storage system according to the Embodiment 2 referring to FIG. 11.

When the delivery is received, or when the delivery is not received despite being to be received because of no available storage box, the storage equipment 10 sends either notification to the user terminal 30 to inform whether received or not received to the resident. At this time, the package data includes the total number of the current deliveries so that the resident being aware of the data can prepare any equipment such as a dolly to carry the delivery in advance.

### (2) Structure of the Storage Equipment 10

As well as the storage equipment 10 according to the aspect of the Embodiment 2 of the present invention referring to FIG. 12, the storage equipment 10 according to the aspect of the Embodiment 5 comprise; a control element 11 that controls the entire storage equipment 10 including e.g., CPU and so forth; a data storage element 12 that stores a variety of data; a data storage element 13 that stores a variety of deliveries to the resident; a display element 14 displaying a variety of data; an operation element 15 having a variety of keys is capable of inputting the data and conducts to read out the data for an authentication written in the residential card and so forth, described later; and a communication element 16 that conducts to send to and receive from the data via a connected network 100.

FIG. 27 is a schematic diagram illustrating each database 121-125 installed in the data storage element 12 according to the aspect of the Embodiment 5 of the present invention.

Referring to FIG. 27, the data storage element 12 stores; the resident DB 121 that controls the authentication data including such as the password needed for the resident to unlock the storage element 12; the storage box DB 122 that controls the location and the use condition of a plurality of storage boxes constituting the storage element 12; and the receiving history DB 124 that controls the receiving history relative to each storage box.

FIG. 28 is a schematic diagram illustrating the data structure of the receiving history DB 124 according to the aspect of the Embodiment 5 of the present invention.

According to the example referring to FIG. 28, the receiving history DB 124 stores the time when the delivery is received and stored, the box number of the storage box therefor, and the resident ID of the addressed resident of the delivery, respectively corresponding to the receiving history number given in order of receiving and storing.

### (3) Structure of the Control Server 20

The control server 20 is a data processing device that is connected to the storage equipment 10 via the network 100 and controls the data relative to the storage of the delivery and so forth as well as the storage equipment 10.

As well as the control server 20 according to the aspect of the Embodiment 2 of the present invention referring to FIG. 15, the control server 20 comprises; a control element 21 having, e.g., CPU and so forth so as to control the entire control server 20; a data storage element 22 so as to store a variety of data; and a communication element 23 so as to send and receive the data via a network 100 to be connected.

The data storage element 22 stores the resident DB 221, the storage box DB 222, and the receiving history DB 224.

The structure of the data of each database 221-224 is respectively the same as each data benchmark 121-124 having the same name and stored in the storage equipment 10.

However, the resident DB 221 controls the private information of the resident (address, phone number and so forth) in addition to the data structure of the resident DB 121.

The inventor skips an explanation of synchronization method between each database 221-224 of the control server 20 and each database 121-124 because of the same aspect of the Embodiment 2.

### (4) Structure of the User Terminal 30

The user terminal 30 is a data processing device operated by e.g., the resident of the housing complex, which can be an portable communication terminal including a smartphone, a mobile phone, PHS (personal handy-phone system) and PDA (personal digital assistant) and or a PC (personal computer) such as a tower computer, a desktop computer and a laptop computer.

As well as the user terminal 30 according to the aspect of the Embodiment 2 of the present invention referring to FIG. 16, the user terminal 30 comprises; a control element 31 having, e.g., CPU and so forth so as to control the entire user terminal 30; a data storage element 32 so as to store a variety of data; and a communication element 33 so as to send and receive the data via a network 100 to be connected; a display element 34 so as to display a variety of data; and an operation element 35 having a variety of keys so as to input such data.

The resident can access the storage equipment 10 by using the user terminal 30 and can make sure the storage status of each storage box (e.g., the box number of the storage box, whether the delivery is stored or not, the size of the delivery, the number of deliveries and so forth.)

### Operation of the Aspect to the Embodiment 5

### (1) Setting Operation of the Private Information

Also according to the aspect of the present Embodiment, the private information and so forth of the resident are controlled in the resident DB 121.

The resident or the person designated by the resident can register or revise the private information to the category benchmark DB 126 by directly inputting thereto by operating the operation element 15 of the storage equipment 10.

The inventor skips the detail explanation of the registration and revising methods of the private information because of the same registration method of the weight benchmark value referring to FIG. 9 (the same aspect of the Embodiment 3.)

In addition, the private information can be set up or revised via the terminal of the control business or in the myPage. The inventor also skips the explanation thereof because it is the same as that the weight benchmark value according to the aspect of the Embodiment 2 is replaced by the private information.

### (2) Storing Operation Relative to the Delivery

FIG. 29 is a schematic flow diagram illustrating the storing operation flow of the delivery relative to the storage system according to the aspect of the Embodiment 5 of the present invention.

Hereinafter, referring to FIG. 26, according to the aspect of the Embodiment, the inventor sets forth the operation relative to the goods storage system when the delivery carrier delivers the delivery addressed to the resident of the housing complex.

Firstly, the delivery carrier attempts to deliver a delivery to a housing complex, and calls the addressed resident to notify that the resident has the delivery through the intercom in the common area or the door phone and makes sure if the resident is available or not.

At this time, when there is no answer from the resident and the resident is not available, the delivery carrier should visit the entrance hall of the housing complex, at which the storage equipment 10 is installed, to temporarily store the delivery addressed to the resident in the storage equipment 10.

Then, the delivery carrier selects “Deposit” by operating the operation element 15 on the selection page of the display element 14 of the storage equipment 10, on which “Deposit” or “Take-out” are displayed (Step S701.)

If “Deposit” is selected, the display element 14 shall display types of service content in accordance with the “Storing the delivery” or the list of businesses to provide the service therefor.

In such displayed page, e.g., a business service content such as “door-to-door delivery”, “laundry service” and “food delivery” or a business name such as “XYZ door-to-door delivery carrier”, “ABC delivery service” is displayed, and the delivery carrier operates the operation element 15 to select the service content and the business name which are corresponding to the carrier per se (Step S702.)

Once the service content and the business name are selected, the display element retrieves the input page of the room number of the addressed housing complex.

Then, the delivery carrier makes sure such as e.g., a delivery bill for the delivery to be stored this time and then operates the operation element 15 to input the addressed room number of the housing unit (Step S703.)

When the addressed room number is input, the control element 11 determines whether any receivable storage boxes are available or not referring to the storage box DB 122 (Step S704.)

Here, if the control element 11 determines that the storage box is available (Step S704 is Yes), the control element 11 displays such available and receivable storage box on the display element 14 (Step S705) and instructs the delivery carrier to store such new delivery in the storage box.

Then, the delivery carrier stores the new delivery in the storage box displayed on the display element 14 and closes the door and then the control element 11 locks such occupied storage box (Step S706.)

Next, the control element 11, referring to the resident DB 121, adds “1” to the total number of the currently stored deliveries addressed to the housing unit having the above room number in the storage equipment 10 to update (Step S707.)

Next, the control element 11 generates the receiving history relative to receiving of the above delivery and records such receiving history in the receiving history DB 124 (Step S708.)

The receiving history to be recorded at this time includes the time when received, the storage box number, the housing unit number of the delivery address and the total stored number of addressed deliveries and so forth, corresponding respectively to the receiving history number identifying each individual history.

Next, the storage equipment 10 determines whether the delivery was received or not (Step 709.)

When it is determined as not received (Step 709 is No), the operation is over.

On the other hand, it is determined that the delivery was received (Step S709 is Yes), the control element 11 generates the package data indicating that the delivery was received based on the above recorded receiving history and notifies the package data to the user terminal 30 of the resident (Step S710.)

The content of such notification can include e.g., receiving of a delivery, the current total number of received deliveries in the storage equipment 10 and the all received storage box numbers and so forth.

In addition, the notification method can include e.g., an e-mail.

When the user terminal 30 receives the above notification, the user terminal displays the content of such notification on the display element 34. The resident makes sure the displayed contents and then goes to the storage equipment 10 to pick up the delivery addressed to oneself.

The operation is now over.

On the other hand, if the control element 11 determines that no storage box is available (Step S704 is No), the control element 11 displays the message that indicates that there is no available storage box to receive such delivery (Step S711) and instructs the delivery carrier to redeliver the delivery.

Then, the control element 11 generates the receiving history relative to non-receiving of the above delivery and records such receiving history in the receiving history DB 124 (Step S708.)

The receiving history to be recorded at this time includes the time when it was attempted to be received, the housing unit number of the delivery address and the total stored number of addressed deliveries and so forth, corresponding respectively to the receiving history number identifying each individual history.

Then, it is determined as not received (Step 709 is No), and the operation is over.

### Summary of the Embodiment 5

As set forth above, according to the aspect of the Embodiment 5 of the present invention, when the delivery carrier stores the delivery in the storage equipment 10, the storage equipment 10 sends a package data including the data of the current total stored number of deliveries addressed to the resident in the storage equipment 10 and the event of receiving to the user terminal 30 so that the resident can understand the total number of deliveries addressed to oneself in advance and can make loaning a dolly in advance when the number of deliveries is big when the resident goes to pick up the deliveries.

As described above, the notification of the package data to the user terminal 30 according to the aspect of the present Embodiment can be executed by using any available methods, including an e-mail, myPage or an application and so forth, but not limited thereto.

The inventor skips an explanation of the notification method of the package data because of the same aspect of the Embodiment 2.

### Summary of Embodiments

As set forth above, a goods storage system of the aspect of the Embodiment 1 or the Embodiment 2 of the present invention, a heavier delivery than the predetermined weight is unacceptable in the storage equipment 10 so that the resident to receive the delivery can request the delivery carrier to redeliver and facilitate to smoothly receive the delivery when it is too hard for the resident to carry the delivery to the own housing unit from the storage equipment 10 because of the heavy delivery.

In addition, a goods storage system of the aspect of the Embodiment 1 or the Embodiment 2 of the present invention, a heavier delivery than the predetermined weight could be stored only in a storage box at the lower rows so that the resident to receive the delivery can facilitate to take out even if the delivery is heavy.

Further, a goods storage system of the aspect of the Embodiment 3 or the Embodiment 4 of the present invention, a delivery of the predetermined category is designated as unacceptable in the storage equipment 10 so that the resident receiving the delivery can request the delivery carrier to directly redeliver to the own housing unit relative to e.g., a delivery that needs to be refrigerated and is expected to be directly delivered and facilitate to smoothly receive such delivery, accordingly.

In addition, a goods storage system of the aspect of the Embodiment 5 of the present invention, the storage equipment 10 controls the total number of current received deliveries every address and sends the notification to the user terminal 30 so that the resident to receive the delivery can prepare such a dolly to carry the delivery to the housing unit from the storage equipment 10 in advance and the resident can avoid to have any problem in which even if the resident comes to the storage equipment 10 to take the delivery, the resident cannot carry to the housing unit because of too many deliveries or too heavy delivery.

The above storage equipment 10, the control server 20 and the user terminal can be brought into reality by mainly software programs loaded in CPU and memories. However, a combination of any hardware and software other than that can configure the equipment and the server and the high freedom of such design can be easily understood by a person skilled in the art.

In addition, when the storage equipment 10, the control server 20, the user terminal 20 or the carrier terminal 30 set forth above constitute a group of software modules; programs stored in an optical recording medium, a magnetic recording medium, a magneto-optical medium, or semiconductors and so forth can be loaded from the above medium or can be loaded from an connected outside device via the preset network.

Further, the above aspects of Embodiments are examples of preferable Embodiments and the aspects of the Embodiment of the present invention are not limited to the examples and a variety of alternative examples can be applied unless departing from the scope of the present invention.

For example, according to the aspect of the Embodiment 1-Embodiment 4 of the present invention, while the storage equipment 10 is operative as the control device to determine storing of a delivery based on the weight of the delivery or the content thereof, the other control device (e.g., control server 20) connected to the storage equipment via a network can determine storing the delivery.

In addition, as set forth above, according to the aspect of the Embodiment 1-Embodiment 5 of the present invention, each storage box of the storage equipment 10 is not locked when no delivery is stored and the storage box is available and will be locked when a delivery is received, but if the weight of the delivery is heavier than the weight benchmark value (non-receiving) or if the type of the delivery is specified as unacceptable, the storage equipment 10 displays the message of non-receiving on the display element 14 to instruct the delivery carrier not to store, but instead of or with displaying such message, the storage box can be configured to lock to reject a new receiving of the delivery.

Further, the weight of the delivery is heavier than the weight benchmark value (designating a storing location), storage boxes other than the storage box, of which the storage location is designated in the weight benchmark DB 126, are locked and can be configured to reject receiving the delivery, accordingly.

Each benchmark value in the above weight benchmark DB 123 can be set up at will based on the delivery method of the delivery, which each resident desires.

For example, if the resident is a senior and wants not to store a heavy delivery in the storage equipment 10 but to directly deliver to the housing unit, each benchmark value can be set up lower to delivery directly to the housing unit or the lower location of the storage equipment 10 can be designated for storing by setting.

On the other hand, if the resident is absent most of the time and wants to store the delivery in the storage equipment 10, the benchmark value is set as relatively higher so that receiving in the higher storage box can be accepted even if a storage box in the lower location is unavailable and the delivery carrier does not have to take back even when the resident is out of the housing unit, accordingly.

Further, according to the aspect of the Embodiment 1 or the Embodiment 2, the storage equipment 10 determines whether the weight of the individual delivery is heavier than the weight benchmark value (non-receiving) or not, but the storage equipment 10 can be configured to determine whether the total weight of a plurality of deliveries is heavier than the weight benchmark value (non-receiving) and to reject storing the deliveries if the total weight thereof is heavier than the weight benchmark value (non-receiving.)

Further, according to the aspect of the Embodiment 2, the storage box in the lower location, from which the delivery can be easily taken out, is specified as an example, but a storage box in any other location can be specified.

Further, a new goods storage system can be configured to have the structure consisting of a combination of configuration elements of goods storage system according to the aspect of the Embodiment 1-the Embodiment 5 of the present invention.

For example, the storage equipment 10 firstly rejects to store the delivery having the weight heavier than the weight benchmark value (non-receiving) based on the weight of the individual delivery newly being received and can also be configured to reject the delivery set as non-receiving in advance.

In addition, each data (e.g., private information, benchmark value and so forth) controlled in each database stored in the storage equipment 10 or the control server 20 can be directly registered by that each resident sends the data and the information thereof to the control server 20 from e.g., the user terminal 30 and so forth, or to the terminal of the control business from the user terminal 30, or transmits contents of each data controlled in each database by phone or fax and so forth to the control business who can register each data in each database.

Further, according to the aspect of the Embodiment 1-the Embodiment 5 of the present invention, as one example, goods stored in the storage equipment 10 is a delivery delivered to the addressed resident by the delivery carrier but goods other than such delivery can be accepted depending on the location and the use of the storage equipment 10.

For example, the goods storage system can be applied for a laundry service; in which the resident of the housing complex deposits a laundry in the storage equipment 10, and the laundry business takes out the laundry therefrom and then after returns the cleaned laundry to the storage equipment 10.

Further, the resident per se of the housing complex can store goods addressed to the other resident of the same housing complex in the storage equipment 10. Following, the other resident as a recipient can take out the goods deposited for oneself. In such case, such goods will not be delivered.

Further, as described above, the storage equipment 10 can be installed to a commercial complex or public facilities and entities and so forth other than the housing complex and in such case, the user cannot be limited to the resident of the housing complex.

### REFERENCE OF SIGN

10 Storage equipment
11, 21, 31 Control element
12, 22, 32 Data storage element
13, 23, 33 Communication element
14, 34 Display element
15, 35 Operation element
16 Storage element
20 Control server
30 User terminal
121, 221 Resident DB
122, 222 Storage box DB
122, 223 Weigh benchmark DB
124, 224 Receiving history DB
125, 225 Notification DB
126, 226 Category benchmark DB

What is claimed is:

1. A storage equipment system, comprising;
at least one storage box system that can receive and store temporarily goods in a storage box until a recipient user takes out the temporary goods from said storage box,
and further comprising;
a weighing system operative to determine a weight of said temporary goods prior to an insertion into said storage box and to transmit said weight to a referencing database for storage;
a database system that controls a predetermined benchmark value weight stored to trigger a rejection of receiving goods heavier than said predetermined bench mark value weight stored by said recipient user prior to receipt of said temporary goods;
said database system storing said benchmark value weight and said weight in a self-referential table in said referencing database relative to each said recipient user; and
wherein once a predetermined benchmark weight of the temporary goods is input by said weighting system when receiving goods, if an input said weight referring to said database is heavier than said predetermined benchmark value, the data base system transmits a signal to said storage box system to trigger a rejection of storage of said receiving goods in said storage box system.

2. A storage equipment system, comprising;
at least one storage box system that can receive and store temporarily goods in a storage box selected from a plurality of storage boxes until a recipient user takes out the temporary goods,
and further comprising;
a database system that designates and controls a location of said storage box receivable of the temporary goods for a plurality of said recipient users and relative to individual said users when a weight of the temporary goods being received in said storage box is heavier than a predetermined benchmark weight,
wherein once said weight of the temporary goods is input when an initial receiving of said temporary goods, if said input weight referring to said database is heavier than said benchmark weight, the a receiving in a storage box in a location other than said a designated location is rejected by said database system.

3. A storage equipment system, comprising;
at least one storage box system that can receive and store temporarily goods in one of a plurality of storage boxes until a recipient user takes out the temporary goods,
and further comprising
a database system that controls a designation location of said temporary goods storage box when weight of the temporary goods being received in said storage box is heavier than a predetermined benchmark weight;
said plurality of said storage boxes including a plurality of lower location storage boxes and elevated storage boxes relative to an external support surface;
wherein once a weight of the temporary goods is input to said database system when receiving said temporary goods, if said input weight referring to said database system is heavier than said benchmark weight, instructing a receiving in one of said lower location storage boxes among an available number of said plurality of storage boxes.

4. A storage equipment comprising;
a storage box system containing a plurality of storage boxes including a plurality of lower location storage boxes and elevated storage boxes relative to an external support surface;
at least one storage box that can receive and store temporarily goods in said storage box until a recipient user takes out the goods; and further comprising;
a database system that controls a location of said temporary goods and designates a receiving storage box from said plurality of storage boxes when a weight of the temporary goods being received in said receiving storage box is lighter than a predetermined benchmark weight; and
wherein once said weight of the temporary goods is input to said database system when receiving said temporary goods, if said input weight is heavier than said predetermined benchmark weight, said database system instructs a receiving in a storage box in a higher location among said plurality of storage boxes.

5. A storage equipment system, comprising;
a storage box system containing a plurality of storage boxes including a plurality of lower location storage boxes and elevated storage boxes relative to an external support surface;
at least one storage box that can receive and store temporarily goods in said storage box until a recipient user takes out the goods;
and further comprising:
a database system that controls an authorized type of temporary goods, and which stores a recipient users designation of authorized types of temporary goods and stores a recipient users designation of unacceptable types of temporary goods for a recipient users designated storage box from among said plurality of storage boxes;
wherein upon an receipt of said temporary goods a type of said temporary good is input into said database system, and said database system conducts a comparison of said type of temporary good with a recipient user's stored designation of unacceptable types and determines a rejection of said temporary goods if said temporary goods is not an authorized type of temporary good.

6. The storage equipment system, according to claim 1, further comprising:
a user access terminal operably connected to said storage equipment system via a remote access network and operated by a recipient user of said temporary goods;
wherein during a use, said storage equipment system sends a package data from said storage equipment system to said user access terminal indicating that said temporary goods were received in said recipient users storage box; and
wherein the package data further includes reporting data relative to the weight of the temporary goods.

7. The storage equipment system, according to claim 5, further comprising;
a user terminal remotely connected to said storage equipment system and said database system via a communication network and operated by said recipient user of said temporary goods,
wherein said user terminal sends data related to said temporary goods and one of said storage boxes to said database system and said storage equipment system

8. A goods storage system, comprising;
a storage equipment system containing a plurality of storage boxes for storing temporary goods;
at least one of said storage boxes operable to receive and store said temporary goods until a recipient user removes the temporary goods from said at least one storage box;
a user communication terminal operable by said recipient user connected to said storage equipment system and said at least one storage box via a communications network; and
wherein said storage equipment system sends a combined report including an indication of receipt of said temporary goods in said at least one storage box to said user communication terminal; and
said combined report further comprising the total number of received and stored temporary goods in the recipient user's own storage box and an addresses location of the temporary goods from said plurality of storage boxes.

9. The storage equipment system, according to claim 6, wherein:
said storage equipment system sends said package data further includes a data displayed on a screen of said user terminal.

10. The storage equipment system, according to claim 1, further comprising:
a user terminal connected to said storage equipment system via a network and operable by said temporary user upon a receipt of said temporary goods, and
a control device connected to said storage equipment system and said user terminal via said network,
wherein said control device sends weight data of the received temporary goods and an indication of receipt of said temporary goods upon an actual receipt of said temporary goods in said storage box system

11. The storage equipment system, according to claim 5, further comprising:
a user terminal connected to said storage equipment system via a network and operated by said temporary user upon a recipient of said temporary goods, and
a control device connected to said storage equipment system and said user terminal via a network; and
wherein upon a receipt of said temporary goods in said storage box, said control device sends a data record of the received temporary goods including data relative to a type of the temporary goods, and a data indication of a received storage box in said plurality of storage boxes to said user terminal.

12. A goods storage system comprising:
a storage equipment system containing a plurality of storage boxes;
at least one storage box that receives and stores temporary goods until a recipient user takes out the temporary goods;
a user terminal that is connected to said storage equipment system via a remote network and operated by the recipient user as a designated recipient user of said temporary goods, and
a control equipment system connected to the storage equipment system and said user terminal via the network, and
wherein said control equipment system sends a data report to said user terminal upon a receipt of said temporary goods in said at least one storage box and said data report includes data indicating a total number of temporary goods stored a storage box owned by said recipient user, and a confirmation of receipt of said temporary goods.

13. The goods storage system, according to claim 12, wherein:
said control equipment system transmits said data report to said user terminal; and
said data report includes a data display on a screen of said user terminal.
